(19) United States
(12) Patent Application Publication
(10) Pub. No.: US 2024/0383801 A1
(43) Pub. Date: Nov. 21, 2024

(54) CHEMICALLY STRENGTHENED GLASS AND PRODUCTION METHOD FOR CHEMICALLY STRENGTHENED GLASS

(71) Applicant: AGC Inc., Tokyo (JP)

(72) Inventors: Yusuke KATAOKA, Tokyo (JP); Yusuke FUJIWARA, Tokyo (JP)

(73) Assignee: AGC Inc., Tokyo (JP)

(21) Appl. No.: 18/659,387

(22) Filed: May 9, 2024

(30) Foreign Application Priority Data
May 19, 2023 (JP) 2023-083362
Apr. 30, 2024 (JP) 2024-073707

(51) Int. Cl. C03C 21/00

(52) U.S. Cl. CPC C03C 21/002; C03C 2203/52

(57) ABSTRACT

A chemically strengthened glass having a thickness t [mm], in which a compressive stress layer depth DOC [μm] is 160t [μm] or more, and a value CS₉₀/ICT [μm⁻¹] obtained by dividing CS₉₀ [MPa] which is a compressive stress value at a depth of 90 μm from a surface of the chemically strengthened glass by a tensile stress integrated value ICT [MPa·μm] is 0.0012 μm⁻¹ or more.

### CROSS-REFERENCE TO RELATED APPLICATIONS

This application is based on and claims priority from Japanese Patent Application No. 2023-083362 filed on May 19, 2023 and Japanese Patent Application No. 2024-073707 filed on Apr. 30, 2024, the entire content of which is incorporated herein by reference.

### TECHNICAL FIELD

The present invention relates to a chemically strengthened glass and a method for producing a chemically strengthened glass.

### BACKGROUND ART

A chemically strengthened glass is used for a cover glass or the like of a mobile terminal. The chemically strengthened glass is obtained by bringing a glass into contact with a molten salt composition such as sodium nitrate to cause ion exchange between an alkali metal ion contained in the glass and an alkali metal ion contained in the molten salt composition and having a larger ion radius, and forming a compressive stress layer on a surface portion of the glass. The strength of the chemically strengthened glass depends on a stress profile represented by a compressive stress value (hereinafter also abbreviated as CS) with the depth from the glass surface as a variable.

The cover glass or the like of the mobile terminal may crack due to deformation during a drop or the like. In order to prevent such a crack, that is, a crack due to bending, it is effective to increase the compressive stress on the glass surface. Therefore, in recent years, it is common to form a high surface compressive stress of 700 MPa or more.

On the other hand, the cover glass or the like of the mobile terminal may also crack due to collision with a protrusion when the terminal drops onto an asphalt surface or grit. In order to prevent such a crack, that is, a crack due to an impact, it is effective to improve the strength by increasing the compressive stress layer depth and forming a compressive stress layer to a deeper portion of the glass.

For example, Patent Literature 1 discloses that CS₉₀ which is a stress value at a depth of 90 μm from the glass surface is a value that contributes to improving cracking resistance due to the impact during a drop.

On the other hand, when the compressive stress layer is formed on a surface portion of a glass article, a tensile stress (hereinafter also abbreviated as CT) necessarily occurs in a center portion of the glass article according to a total compressive stress. When the CT value is too large, the glass article cracks violently and fragments thereof are scattered during damage. When the CT value is greater than a threshold value (hereinafter also abbreviated as a CT limit), the glass may self-destruct, resulting in an explosive increase in the number of fragments during damage. The CT limit is a value specific to the glass composition.

Therefore, in a chemically strengthened glass, while the surface compressive stress is set to be large and the compressive stress layer is formed to a deeper portion, the total surface compressive stress is designed such that the CT value is not greater than the CT limit.

As one of indices for evaluating the strength of a glass-based material for use in smartphones, there is a “set drop strength test”. The “set drop strength test” is a test of dropping a sample obtained by laminating a smartphone casing or a mock plate simulating a smartphone and a glass-based material, and using a drop height at which a crack occurs as the index of the strength. The set drop strength is an index that can reflect the strength of the glass-based material when used as a product.

### CITATION LIST

### Patent Literature

Patent Literature 1: WO 2022/181812

### SUMMARY OF INVENTION

In Patent Literature 1, the set drop strength is improved by performing a chemical strengthening treatment using a predetermined method that focuses on the CT limit. However, in some cases, it is insufficient from the viewpoint of increasing the CS₉₀ in the stress profile.

Therefore, an object of the present invention is to provide a chemically strengthened glass that has a larger CS₉₀ with respect to a total compressive stress and thereby has excellent set drop strength. Another object of the present invention is to provide a chemically strengthened glass production method that can make the larger CS₉₀ with respect to the total compressive stress and thereby improve the set drop strength.

As a result of intensive study, the inventors of the present invention have found that when an appropriate heat treatment is performed after a first ion exchange treatment and before a second ion exchange treatment in production of a chemically strengthened glass by two or more stages of ion exchange treatment, the CS₉₀ of the obtained chemically strengthened glass can be made larger with respect to the total compressive stress. The present invention has thus been completed.

That is, the present invention relates to the following 1 to 13.

1. A chemically strengthened glass having a thickness t [mm], in which
a compressive stress layer depth DOC [μm] is 160t [μm] or more, and
a value CS₉₀/ICT [μm⁻¹] obtained by dividing CS₉₀ [MPa] which is a compressive stress value at a depth of 90 μm from a surface of the chemically strengthened glass by a tensile stress integrated value ICT [MPa·μm] is 0.0012 μm⁻¹ or more.

2. The chemically strengthened glass according to the above 1, in which the CS₉₀ is 5+50t [MPa] or more.

3. The chemically strengthened glass according to the above 1 or 2, in which a value DOC/CS₅₀ obtained by dividing the DOC by CS₅₀ [MPa] which is a compressive stress value at a depth of 50 μm from the surface of the chemically strengthened glass is 0.8 μm/MPa or more.

4. The chemically strengthened glass according to the above 1 or 2, in which a value CS₉₀/CS₅₀ obtained by dividing the CS₉₀ by the CS₅₀ [MPa] which is the compressive stress value at the depth of 50 μm from the surface of the chemically strengthened glass is 0.30 or more.

5. The chemically strengthened glass according to the above 1 or 2, in which in a profile of a stress value CSₓ [MPa] at a depth x [μm] from the surface of the chemically strengthened glass as measured with a scattered light photoelastic stress meter, a first-order differential value CSₓ′ of the stress value CSₓ in a range of CSₓ≥0 is less than 2.

6. The chemically strengthened glass according to the above 1 or 2, in which in the profile of the stress value CSₓ [MPa] at the depth x [μm] from the surface of the chemically strengthened glass as measured with the scattered light photoelastic stress meter, a second-order differential value CSₓ″ of the stress value CSₓ in the range of CSₓ≥0 is −0.02 to 0.06.

7. The chemically strengthened glass according to the above 1 or 2, in which a surface compressive stress value CS₀ is 750 MPa or more as measured with a film stress measurement.

8. The chemically strengthened glass according to the above 1 or 2, in which a set drop strength is 40.5 cm or more as measured by a sandpaper set drop strength test under the following conditions,
conditions: an electronic device mounted with the chemically strengthened glass, or an electronic device simulating structure in which the chemically strengthened glass and a casing for holding the chemically strengthened glass are integrated with each other, is dropped from a height of 30 cm onto #80 sandpaper; when the chemically strengthened glass does not crack, a drop height is increased by 5 cm and dropping is performed again; as long as the chemically strengthened glass does not crack after dropping, a step of dropping from a drop height increased by 5 cm is repeated; a height at which the chemically strengthened glass first cracks is defined as a crack height; and the drop test is performed for 10 samples, and an average crack height of the 10 samples is defined as the set drop strength.

9. A chemically strengthened glass having a thickness t [mm], in which
an Na ion diffusion depth determined based on an Na ion concentration profile in a sheet thickness direction of the chemically strengthened glass as measured by using an electron probe micro analyzer is 290t [μm] or more, and
a ratio ΔNa90/ΔNa50 is 0.55 or more, where the ΔNa50 [mol %] is a difference between an Na₂O concentration in a base composition of the chemically strengthened glass and an Na₂O concentration at a depth of 50 μm from a surface of the chemically strengthened glass, and the ΔNa90 [mol %] is a difference between the Na₂O concentration in the base composition of the chemically strengthened glass and an Na₂O concentration at a depth of 90 μm from the surface of the chemically strengthened glass.

10. The chemically strengthened glass according to the above 9, in which a ratio of the ΔNa90 [mol %] to the Na₂O concentration [mol %] in the base composition of the chemically strengthened glass is 1.26 or more.

11. A production method for a chemically strengthened glass, the method including:
a first ion exchange treatment of bringing a glass for chemical strengthening into contact with a first molten salt composition; and
a second ion exchange treatment of bringing the glass for chemical strengthening into contact with a second molten salt composition after the first ion exchange treatment, in which
the method further includes a heat treatment after the first ion exchange treatment and before the second ion exchange treatment,
a first ion exchange treatment temperature T_{CT} [° C.] and a first ion exchange time t_{CT} [minutes] are in a range where a strengthening index (H value) defined by the following equation is 10600 or less, and
in the heat treatment, a heat treatment effect index value (I value) defined by the following equation is 220 or more.

$$H = ( {T}_{CT} + 273 ) \times \sqrt{{t}_{CT}} \qquad [ Math . 1 ]$$

$$I = \frac{\sum [ {Me}_{2} O ] \times \sqrt{{t}_{d}} \times ( {T}_{d} + 273 )}{3 {t}_{CT}} + {t}_{CT} \qquad [ Math . 2 ]$$

In the equations,
t_{CT} is a treatment time [minutes] of the first ion exchange treatment,
T_{CT} is a temperature [° C.] of the first ion exchange treatment,
Σ[Me₂O] is a total concentration [mol %] of alkali metal ion oxides in the glass for chemical strengthening,
t_{d} is a time [minutes] during which the glass for chemical strengthening is left at a temperature of 80% or more of the first ion exchange treatment temperature T_{CT} [° C.] as the heat treatment, and
T_{d} is a temperature [° C.] of the heat treatment.

12. The production method for a chemically strengthened glass according to the above 11, in which the heat treatment temperature T_{d} [° C.] is 360° C. or higher, or the heat treatment time t_{d} [minutes] is 10 minutes or longer.

13. The production method for a chemically strengthened glass according to the above 11 or 12, in which
when the glass for chemical strengthening has a CTA value determined according to the following equation (1) of x [MPa], a CTave value of the glass for chemical strengthening, which is determined according to the following equation (2), is made greater than x [MPa] by the first ion exchange treatment, and the CTave value of the glass for chemical strengthening is made less than x [MPa] by the second ion exchange treatment.

$$\begin{matrix}[ Math . 3 ] & \\ CTA = 317.93 \times K 1 c / \sqrt{t} + 228.5 \times t - 398 & Equation ( 1 )\end{matrix}$$

t: sheet thickness [mm],
K1c: fracture toughness value [MPa·m^{1/2}]

$$CTave = ICT / LCT , \qquad Equation ( 2 )$$

ICT: tensile stress integrated value [MPa·μm], and
LCT: sheet thickness direction length [μm] of tensile stress region.

According to the present invention, it is possible to provide a chemically strengthened glass that has a larger CS₉₀ with respect to a total compressive stress and thereby has excellent set drop strength. In addition, according to the present invention, when an appropriate heat treatment is performed after the first ion exchange treatment and before the second ion exchange treatment, it is possible to provide a chemically strengthened glass production method that can make the larger CS₉₀ with respect to the total compressive stress and thereby improve the set drop strength.

### BRIEF DESCRIPTION OF DRAWINGS

FIG. 1 is a diagram showing an example of a stress profile of a chemically strengthened glass according to the present embodiment, as measured with an SLP.

FIG. 2 is a diagram showing an example of an Na ion concentration profile in a sheet thickness direction of the chemically strengthened glass according to the present embodiment.

FIG. 3 is a diagram schematically illustrating steps in a chemical strengthening treatment.

FIGS. 4A and 4B are each a diagram showing an example of the stress profile of the chemically strengthened glass according to the present embodiment. The stress profile shown in each of FIGS. 4A and 4B is prepared by combining stress profile information of a glass surface layer measured by using an SLP and stress profile information inside the glass measured by using an FSM.

### DESCRIPTION OF EMBODIMENTS

In the present description, “to” indicating a numerical range is used in the sense of including the numerical values set forth before and after the “to” as a lower limit value and an upper limit value. In the present description, a composition (content of each component) of a glass is expressed in mole percentage in terms of oxide, unless otherwise specified, and mol % is simply expressed as “%”.

In the present description, “not substantially contained” means that a component has a content equal to or less than an impurity level contained in raw materials and the like, that is, the component is not intentionally added. Specifically, the content is, for example, less than 0.1%.

In the present description, an “amorphous glass” refers to a glass in which a diffraction peak indicating a crystal is not observed in powder X-ray diffraction. A “crystallized glass” is obtained by subjecting the “amorphous glass” to a heat treatment to precipitate crystals, and contains crystals. In the present description, the “amorphous glass” and the “crystallized glass” may be collectively referred to as a “glass”. The amorphous glass to be a crystallized glass by a heat treatment may be referred to as a “base glass of the crystallized glass”.

In the following, a “chemically strengthened glass” refers to a glass after a chemical strengthening treatment, and a “glass for chemical strengthening” refers to a glass before the chemical strengthening treatment.

### <Stress Measurement Method>

In recent years, a glass that has undergone two or more stages of chemical strengthening by exchanging lithium ions inside the glass with sodium ions (Li—Na exchange), and then exchanging the sodium ions inside the glass with potassium ions (Na—K exchange) on a surface layer portion of the glass has become mainstream for a cover glass of a smartphone and the like.

In order to acquire a stress profile of such a chemically strengthened glass in a non-destructive manner, for example, a scattered light photoelastic stress meter (hereinafter also abbreviated as an SLP), a film stress measurement (hereinafter also abbreviated as an FSM), or the like may be used in combination.

In a method using the scattered light photoelastic stress meter (SLP), a compressive stress derived from the Li—Na exchange can be measured inside the glass at a depth of several tens of μm or more from a glass surface layer.

On the other hand, in a method using the film stress measurement (FSM), the compressive stress derived from the Na—K exchange can be measured in a surface layer portion of the glass, which is at a depth of several tens of μm or less from the glass surface (for example, WO 2018/056121 and WO 2017/115811).

Therefore, as a stress profile in the glass surface layer and inside of the two-stage chemically strengthened glass, a combination of SLP information and FSM information is sometimes used.

In the present description, compressive stresses CS₀ and CS₁, and a surface layer compressive stress layer depth DOL-tail are values measured with a film stress measurement (FSM), and compressive stresses CS₅₀ and CS₉₀, a tensile stress CT, and a compressive stress layer depth DOC are values measured with a scattered light photoelastic stress meter (SLP). The surface layer compressive stress layer depth DOL-tail refers to a maximum depth of the compressive stress layer that can be measured by an FSM.

The scattered light photoelastic stress meter is a stress measuring device including: a polarization phase difference variable member that changes a polarization phase difference of laser light by one wavelength or more with respect to a wavelength of the laser light; an imaging element that acquires a plurality of images by imaging, a plurality of times at predetermined time intervals, scattered light emitted when the laser light having the variable polarization phase difference is incident on a strengthened glass; and a calculation unit that measures a periodic luminance change of the scattered light using the plurality of images, calculates a phase change of the luminance change, and calculates a stress distribution in a depth direction from a surface of the strengthened glass based on the phase change.

A method for measuring the stress profile by using the scattered light photoelastic stress meter includes a method described in WO 2018/056121. Examples of the scattered light photoelastic stress meter include SLP-1000 and SLP-2000 manufactured by Orihara industrial Co., Ltd. A combination of attached software SlpIV_up3 (Ver. 2019.01.10.001) with these scattered light photoelastic stress meters enables highly accurate stress measurement.

### <CTave>

In the present description, “CTave” (MPa) is determined according to the following equation. The CTave is a value corresponding to a tensile stress average value, and is a value obtained by integrating stress values in a tensile stress region in a full width of the sheet thickness and dividing the integrated value by a length of the tensile stress region.

$$CTave = ICT / LCT$$

ICT: tensile stress integrated value (MPa·μm)
LCT: sheet thickness direction length (μm) of tensile stress region

### <CSₓ>

In the present description, the “CSₓ” is a compressive stress value (MPa) at a depth x (μm) from the glass surface.

### <Na Ion Concentration Profile>

In the present description, an Na ion concentration at a depth x (μm) is obtained by measuring a concentration in a cross section in the sheet thickness direction by using an electron probe micro analyzer (EPMA). Specifically, the measurement by using an EPMA is performed as follows, for example.

First, a glass sample is embedded with an epoxy resin and mechanically polished in a direction perpendicular to a first main surface and a second main surface opposite to the first main surface to prepare a cross section sample. A C coat is applied to the polished cross section, and measurement is performed by using an EPMA (JXA-8500F manufactured by JEOL Ltd.). A line profile of an X-ray intensity of each of the Na ion concentration and an Si ion concentration is acquired at an interval of 1 μm at an acceleration voltage of 15 kV, a probe current of 30 nA, and an integration time of 1000 msec./point. The obtained Na ion concentration profile is normalized by being divided by an average count of the Si ion concentration at a sheet thickness center portion (500×t)±25 am (sheet thickness t [mm]). An Na₂O concentration at a specific depth is calculated by proportionally converting counts of the entire sheet thickness into Na₂O concentration in mol %, assuming that the average count at the sheet thickness center portion (500×t)±25 μm (sheet thickness t [mm]) corresponds to an Na₂O concentration in a base composition of a chemically strengthened glass.

Hereinafter, embodiments of the present invention will be described in detail, but the present invention is not limited to the following embodiments, and can be freely modified and implemented without departing from the gist of the present invention. For example, for a plurality of embodiments described in the present description, preferred aspects of each embodiment may be combined with each other, or a part of each embodiment may be replaced with a preferred aspect of another embodiment.

### <Chemically Strengthened Glass Production Method>

A chemically strengthened glass production method according to an embodiment of the present invention (hereinafter, also referred to as the present production method) includes: a first ion exchange treatment of bringing a glass for chemical strengthening into contact with a first molten salt composition; and a second ion exchange treatment of bringing a second molten salt composition into contact with the glass for chemical strengthening after the first ion exchange treatment, and in the ion exchange treatment, a strengthening index value (H value) defined by the following equation is 10600 or less. The chemically strengthened glass production method according to the embodiment of the present invention includes a heat treatment after the first ion exchange treatment and before the second ion exchange treatment, and in the heat treatment, a heat treatment effect index value (I value) defined by the following equation is 220 or more.

$$H = ( {T}_{CT} + 273 ) \times \sqrt{{t}_{CT}} \qquad [ Math . 4 ]$$

$$I = \frac{\sum [ {Me}_{2} O ] \times \sqrt{{t}_{d}} \times ( {T}_{d} + 273 )}{3 {t}_{CT}} + {t}_{CT} \qquad [ Math . 5 ]$$

In the above equations,
t_{CT} is a treatment time [minutes] of the first ion exchange treatment,
T_{CT} is a temperature [° C.] of the first ion exchange treatment,
Σ[Me₂O] is a total concentration [mol %] of alkali metal ion oxides in the glass for chemical strengthening,
t_{d} is a time [minutes] during which a glass for chemical strengthening is left at a temperature of 80% or more of the first ion exchange treatment temperature T_{CT} [° C.] as the heat treatment, and
T_{d} is a temperature [° C.] of the heat treatment.

The chemical strengthening treatment is a treatment in which a glass is brought into contact with a metal salt by a method of immersing a glass into a melt of a metal salt (for example, potassium nitrate) containing metal ions having a large ion radius (typically, Na ions or K ions), and thereby metal ions having a small ion radius (typically, Na ions or Li ions) in the glass are substituted with the metal ions having a large ion radius (typically, Na ions or K ions for Li ions, and K ions for Na ions).

In order to increase a rate of the chemical strengthening treatment, it is preferable to use “Li—Na exchange” in which Li ions in the glass are exchanged with Na ions. In addition, in order to form a large compressive stress by ion exchange, it is preferable to use “Na—K exchange” in which Na ions in the glass are exchanged with K ions.

The present production method includes, as such a chemical strengthening treatment, a first ion exchange treatment of bringing a glass for chemical strengthening into contact with a first molten salt composition, and a second ion exchange treatment of bringing a second molten salt composition into contact with the glass for chemical strengthening after the first ion exchange treatment. The chemical strengthening treatment may be performed by two stages of ion exchange, i.e., a first ion exchange treatment and a second ion exchange treatment, or may be performed by three or more stages of ion exchange including a further ion exchange treatment.

In the present production method, a first ion exchange treatment temperature T_{CT} [° C.] and a first ion exchange time t_{CT} [minutes] are in a range where a strengthening index (H value) defined by the following equation is 10600 or less, a heat treatment is included after the first ion exchange treatment and before the second ion exchange treatment, and in such a heat treatment, a heat treatment effect index value (I value) defined by the following equation is 220 or more.

$$H = ( {T}_{CT} + 273 ) \times \sqrt{{t}_{CT}} \qquad [ Math . 6 ]$$

$$I = \frac{\sum [ {Me}_{2} O ] \times \sqrt{{t}_{d}} \times ( {T}_{d} + 273 )}{3 {t}_{CT}} + {t}_{CT} \qquad [ Math . 7 ]$$

In the above equations,
t_{CT} is a treatment time [minutes] of the first ion exchange treatment,
T_{CT} is a temperature [° C.] of the first ion exchange treatment,
Σ[Me₂O] is a total concentration [mol %] of alkali metal ion oxides in the glass for chemical strengthening,
t_{d} is a time [minutes] during which a glass for chemical strengthening is left at a temperature of 80% or more of the first ion exchange treatment temperature T_{CT} [° C.] as the heat treatment, and
T_{d} is a temperature [° C.] of the heat treatment.

The inventors of the present invention have found that when an appropriate heat treatment is performed in a first ion exchange treatment and an appropriate heat treatment is performed after the first ion exchange treatment and before a second ion exchange treatment in production of a chemically strengthened glass by two or more stages of ion exchange treatment, the CS₉₀ of the obtained chemically strengthened glass can be made larger with respect to the total compressive stress. That is, it has been found that when a heat treatment in which the heat treatment effect index value (I value) is 220 or more is performed after the first ion exchange treatment and before the second ion exchange treatment in which the H value defined by the above equation is in the range of 10600 or less, the CS₉₀ of the obtained chemically strengthened glass can be made larger with respect to the total compressive stress. The present invention has thus been completed.

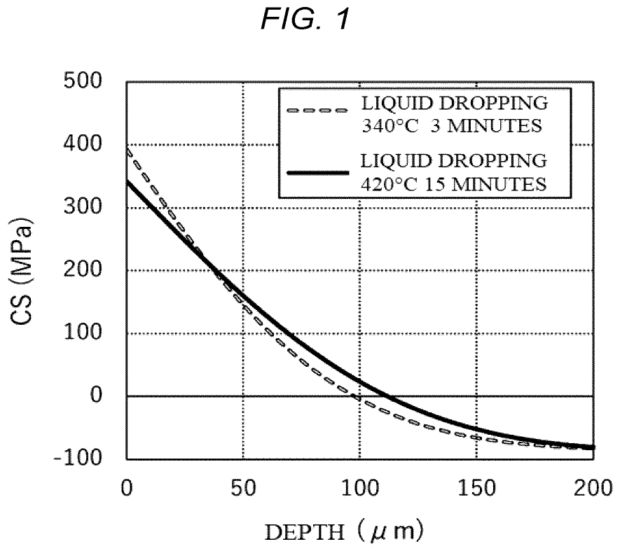

FIG. 1 is a diagram showing an example of a stress profile of a chemically strengthened glass obtained by the present production method, as measured with an SLP. The solid line in FIG. 1 is a stress profile of a chemically strengthened glass (Example 3 in Examples) obtained by the present production method. The dashed line is a stress profile of a chemically strengthened glass (Example 5 in Examples) obtained in the same manner as the chemically strengthened glass shown by the solid line except that the heat treatment time and temperature are changed and the heat treatment effect index value (I value) is set to be less than 220. As can be seen from FIG. 1, comparing the chemically strengthened glasses in Example 5 and Example 3, Example 3 has a larger CS₉₀ while maintaining the same level of CS₅₀. It can also been seen that as the CS₉₀ increases, the DOC also increases. In addition, as detailed in Examples, Example 3, which is a chemically strengthened glass obtained by the present production method, has a CS₉₀/ICT value larger than that in Example 5. Here, CS₉₀/ICT is an index of the magnitude of the CS₉₀ value with respect to the total compressive stress introduced into the chemically strengthened glass, and the details thereof will be described later.

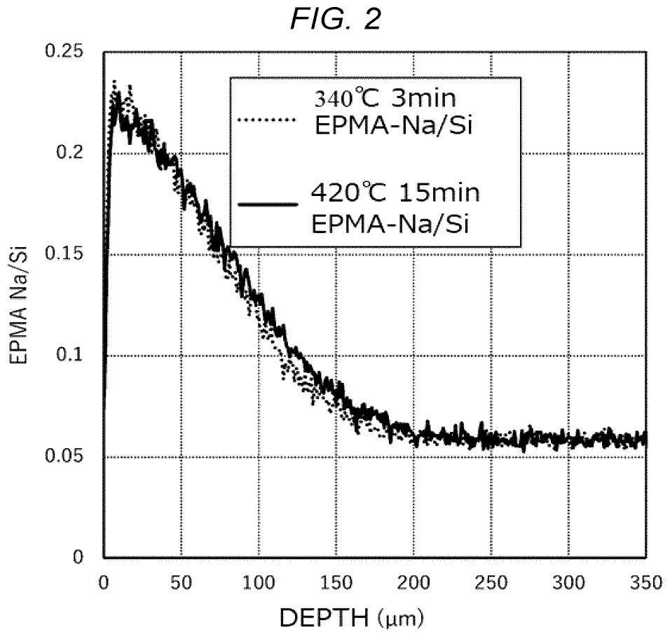

The reason why the CS₉₀ can be increased by the present production method in this way is thought to be that, with a heat treatment, alkali metal ions introduced in the first ion exchange treatment are further diffused toward a deep portion of the glass, further increasing the compressive stress in the deep portion. FIG. 2 is a diagram showing Na ion concentration profiles in the thickness direction of the chemically strengthened glasses in Example 5 and Example 3 illustrated in FIG. 1, as measured by an electron probe micro analyzer. The solid line shows the chemically strengthened glass in Example 3, and the dashed line shows the chemically strengthened glass in Example 5. As can be seen from the comparison between the Na ion concentration profiles of the chemically strengthened glasses in Example 5 and Example 3, actually, the chemically strengthened glass in Example 3 has a larger Na ion concentration near a depth of 90 μm and a larger Na ion diffusion depth, as in the case of the stress profile.

It is thought that, for example, increasing the heat treatment temperature to promote thermal movement of alkali ions contained in the glass may contribute to increasing such an effect of the heat treatment. Alternatively, it is thought that increasing the heat treatment time to increase the amount of heat applied in the heat treatment may contribute to the above effect. Regarding this, since the diffusion depth is proportional to the square root of the diffusion time according to the diffusion equation, it is thought that the heat treatment effect is also proportional to the square root of the heat treatment time. In addition, it is thought that, in the case where the total concentration of alkali metal ions in the glass for chemical strengthening is larger, increasing the total amount of the alkali ions contained in the glass makes it more susceptible to the heat treatment. Further, it is thought that, in the case where the treatment time of the first ion exchange treatment is longer, increasing the total amount of the alkali ions contained in the glass after chemical strengthening makes it more susceptible to the heat treatment.

Indices based on these findings are the above-described strengthening index (H value) and heat treatment effect index value (I value). When the strengthening index (H value) in the first ion exchange treatment is 10600 or less and a heat treatment is performed under the conditions that the heat treatment effect index value (I value) is 220 or more before the second ion exchange treatment, a chemically strengthened glass having an increased CS₉₀ can be obtained.

In the present production method, the heat treatment effect index value (I value) is 220 or more, preferably 230 or more, more preferably 240 or more, and still more preferably 250 or more, from the viewpoint of obtaining the above effects. The heat treatment effect index value (I value) is preferably 300 or less, more preferably 280 or less, and still more preferably 270 or less, from the viewpoint of preventing relaxation of a generated stress.

As described above, in order to make the heat treatment effect index value (I value) 220 or more, it is preferable to appropriately control each of Σ[Me₂O], t_{d}, T_{d}, and t_{CT}. As described above, Σ[Me₂O] is the total concentration of the alkali metal ion oxides [mol %] in the glass for chemical strengthening, t_{d} is the heat treatment time [minutes], T_{d} is the heat treatment temperature [° C.], and t_{CT} is the treatment time [minutes] of the first ion exchange treatment.

For example, it is preferable that the heat treatment temperature T_{d} [° C.] is 360° C. or higher, or the heat treatment time t_{d} [minutes] is 10 minutes or longer. Accordingly, it is relatively easy to increase the heat treatment effect index value (I value).

Σ[Me₂O] is preferably 5 mol % or more, more preferably 6 mol % or more, still more preferably 7 mol % or more, particularly preferably 8 mol % or more, and most preferably 9 mol % or more, from the viewpoint of increasing the heat treatment effect index value (I value). On the other hand, Σ[Me₂O] is preferably 35 mol % or less, more preferably 30 mol % or less, still more preferably 25 mol % or less, particularly preferably 20 mol % or less, and most preferably 18 mol % or less, from the viewpoint of formability of the glass. Σ[Me₂O] is the total concentration of the alkali metal ions in the glass for chemical strengthening, and is specifically a total [mol %] of concentrations of Li₂O, Na₂O, and K₂O expressed in mole percentage in terms of oxide.

The heat treatment temperature T_{d} [° C.] is preferably 360° C. or higher, more preferably 365° C. or higher, still more preferably 370° C. or higher, particularly preferably 375° C. or higher, and most preferably 380° C. or higher, from the viewpoint of increasing the heat treatment effect index value (I value). On the other hand, the heat treatment temperature T_{d} [° C.] is preferably 500° C. or lower, more preferably 490° C. or lower, still more preferably 480° C. or lower, particularly preferably 470° C. or lower, and most preferably 460° C. or lower, from the viewpoint of preventing relaxation of a generated stress.

The heat treatment time t_{d} [minutes] is preferably 10 minutes or longer, more preferably 15 minutes or longer, still more preferably 20 minutes or longer, particularly preferably 25 minutes or longer, and most preferably 30 minutes or longer, from the viewpoint of increasing the heat treatment effect index value (I value). On the other hand, the heat treatment time t_{d} [minutes] is preferably 120 minutes or shorter, more preferably 105 minutes or shorter, still more preferably 90 minutes or shorter, particularly preferably 75 minutes or shorter, and most preferably 70 minutes or shorter, from the viewpoint of preventing a decrease in productivity.

The treatment time [minutes] of the first ion exchange treatment is preferably 150 minutes or longer, more preferably 180 minutes or longer, still more preferably 200 minutes or longer, and particularly preferably 220 minutes or longer, from the viewpoint of sufficiently introducing stress energy that can be transferred to a deep layer by the heat treatment. On the other hand, the treatment time [minutes] of the first ion exchange treatment is preferably 360 minutes or shorter, more preferably 330 minutes or shorter, still more preferably 300 minutes or shorter, particularly preferably 270 minutes or shorter, and most preferably 250 minutes or shorter, from the viewpoint of preventing a decrease in productivity.

It is sufficient that the heat treatment is performed after the first ion exchange treatment and before the second ion exchange treatment, and the specific method thereof is not particularly limited. Note that, it is sufficient that “after the first ion exchange treatment” is after the chemically strengthened glass is taken out from the first molten salt composition in the first ion exchange treatment, and it is sufficient that “before the second ion exchange treatment” is any time before the chemically strengthened glass is immersed in the second molten salt composition in the second ion exchange treatment. Specific examples thereof include a “liquid dropping step” of dropping a molten salt adhering by the first ion exchange treatment, a “heating step” of heating the glass that has been taken out and subjected to the first ion exchange treatment, and a “preheating step” of heating the glass after the first ion exchange treatment before being subjected to the second ion exchange treatment.

The chemical strengthening treatment includes, for example, the following steps (a) to (d) in this order. Here, in the present production method, it is preferable to perform a heat treatment in the liquid dropping step (c) after performing the first ion exchange treatment (strengthening step (b)). Accordingly, the effects of the present invention can be efficiently obtained without making the process complicated.
(a) preheating step
(b) strengthening step (ion exchange treatment)
(c) liquid dropping step
(d) taking-out step

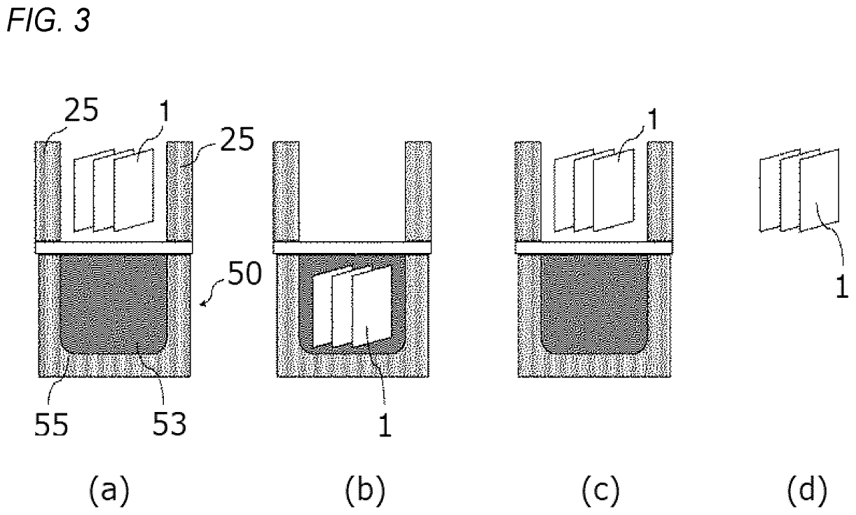

FIG. 3 shows diagrams schematically illustrating the steps (a) to (d) above, and (a) to (d) in FIG. 3 correspond to the steps (a) to (d) above, respectively.

In the preheating step (a), a glass for chemical strengthening 1 is heated in advance before being immersed in a molten salt composition 53. By performing the preheating step, glass cracks due to a thermal impact when charged into a molten salt can be prevented. For example, it is preferable to heat the glass for chemical strengthening to a temperature in the range of −80° C. to +80° C. with respect to the temperature of a molten salt composition in the strengthening step (b). The preheating step may be performed by a known method, and for example, as shown in FIG. 3, the glass for chemical strengthening 1 can be heated by using an atmosphere heater 25 provided on a molten salt bath 50. In FIG. 3, the molten salt bath 50 is equipped with a molten salt heater 55, and the molten salt composition 53 is heated by the molten salt heater 55.

In the strengthening step (b), the glass for chemical strengthening 1 is immersed in the molten salt composition 53 to be subjected an ion exchange treatment. Preferred conditions for the ion exchange treatment will be detailed later.

The liquid dropping step (c) is a step of taking the glass for chemical strengthening 1 out of the molten salt composition 53, followed by being left to stand for a predetermined period of time, thereby allowing the molten salt composition adhering to the glass for chemical strengthening 1 to drop naturally and be removed. In the liquid dropping step (c), in order to maintain a molten state of the molten salt composition adhering to the glass for chemical strengthening 1, the glass for chemical strengthening 1 is heated by using the atmosphere heater 25 or the like as shown in FIG. 3. Here, when heating conditions are set to the above-described preferred heat treatment conditions and the heat treatment effect index value (I value) is set to 220 or more, the heat treatment in the present production method can be performed in the liquid dropping step. It is preferable that the heat treatment in the present production method is performed in the liquid dropping step in this way, since the CS₉₀ of the obtained chemically strengthened glass can be increased without complicating the process and it is difficult to exceed the CT limit when the chemically strengthened glass is taken out from the strengthening furnace.

In the taking-out step (d), the chemically strengthened glass (glass for chemical strengthening) is taken out of a chemical strengthening treatment device. The chemically strengthened glass (glass for chemical strengthening) taken out may be subjected to a cleaning step or a decorating step, for example. Then, if it is necessary to perform the next step of ion exchange treatment, the steps (a) to (d) may be performed again. The present production method includes two stages of ion exchange treatment. Therefore, specifically, for example, a first step (a), a first step (b) which is a first ion exchange treatment, a first step (c) in which the heat treatment in the present production method is performed, a first step (d), a second step (a), a second step (b) which is a second ion exchange treatment, a second step (c), and a second step (d) may be included in this order. In the present production method, in the case where a total of two or more heating steps are included between the first ion exchange treatment and the second ion exchange treatment, a total of the heat treatment effect index values in respective heating steps is preferably 220 or more.

Although the case where the heat treatment of the present production method is performed in the liquid dropping step is illustrated above, the heat treatment of the present production method may be performed in a step other than the liquid dropping step. For example, the heat treatment of the present production method may be performed in the second step (a), or the heat treatment of the present production method may be performed by using a separately prepared heating device or the like after the first step (d).

Note that, in the liquid dropping step, the molten salt composition adheres to the surface of the glass for chemical strengthening, but the amount is smaller than that in the case where the glass for chemical strengthening is immersed in the molten salt composition. Therefore, it is thought that, even when the heat treatment in the present production method is performed in the liquid dropping step, ion exchange or the like does not occur to the extent that it influences the obtained chemically strengthened glass. In addition, the diffusion of the alkali metal ions toward the deep portion of the glass due to the heat treatment in the present production method is a phenomenon that occurs inside the glass. For these reasons, even when the heat treatment in the present production method is performed in a step other than the liquid dropping step, the effect of increasing the CS₉₀ can also be obtained.

Hereinafter, preferred embodiments of the ion exchange treatment in the present production method will be described in detail.

As described above, the present production method includes a first ion exchange treatment and a second ion exchange treatment. The first molten salt composition used in the first ion exchange treatment and the second molten salt composition used in the second ion exchange treatment generally have different compositions from each other. From the viewpoint that it is easy to obtain a suitable stress profile, the first ion exchange treatment is preferably a treatment mainly using “Li—Na exchange”, and the second ion exchange treatment is preferably a treatment mainly using “Na—K exchange”.

### (First Ion Exchange Treatment)

The first ion exchange treatment is preferably a treatment mainly using the “Li—Na exchange”. In this case, it is preferable to perform the first ion exchange treatment by immersing the glass for chemical strengthening in a first molten salt composition containing sodium ions. Details of the glass for chemical strengthening will be described later, and in order to perform the Li—Na exchange, it is preferable to use a lithium-containing glass as the glass for chemical strengthening.

According to the first ion exchange treatment mainly using the “Li—Na exchange”, lithium ions in the glass are exchanged with sodium ions in the molten salt, whereby sodium can be introduced into a deep layer portion of the glass and a deep compressive stress layer can be formed.

Examples of the molten salt for performing the chemical strengthening treatment include a nitrate, a sulfate, a carbonate, and a chloride. Among them, examples of the nitrate include lithium nitrate, sodium nitrate, potassium nitrate, cesium nitrate, and silver nitrate. Examples of the sulfate include lithium sulfate, sodium sulfate, potassium sulfate, cesium sulfate, and silver sulfate. Examples of the carbonate include lithium carbonate, sodium carbonate, and potassium carbonate. Examples of the chloride include lithium chloride, sodium chloride, potassium chloride, cesium chloride, and silver chloride. These molten salts may be used alone or in combination of plural types thereof.

The molten salt composition is preferably a composition containing a nitrate as a main component, and more preferably a composition containing sodium nitrate or potassium nitrate as a main component. Here, the expression “as a main component” means that a content in the molten salt composition is 80 mass % or more.

It is preferable that the content of sodium nitrate in the first molten salt composition is more than 40 mass %. In a first embodiment, the content of sodium nitrate in the first molten salt composition may be 65 mass % or more, 75 mass % or more, 85 mass % or more, or 95 mass % or more. When the content of sodium nitrate is within the above range, in the first ion exchange treatment, the “Li—Na exchange” increases the amount of sodium that enters the deep layer of the glass, leading to the effect of increasing the CS₉₀.

On the other hand, in the case of adding potassium nitrate to the first molten salt composition, the content thereof may be 65 mass % or less, 45 mass % or less, 25 mass % or less, or 15 mass % or less. When the content of potassium nitrate is within the above range, since the “Li—Na exchange” functions more dominantly than the “Na—K exchange”, sodium ions can be sufficiently introduced into the deep layer portion of the glass.

In the first ion exchange treatment, the glass for chemical strengthening is preferably immersed in the first molten salt composition at a temperature of preferably 360° C. or higher. When the temperature of the first molten salt composition is 360° C. or higher, the ion exchange easily progresses, and the compressive stress can be introduced to a range of greater than the CT limit. The temperature is more preferably 380° C. or higher, and still more preferably 400° C. or higher. The temperature of the first molten salt composition is generally 450° C. or lower from the viewpoint of danger caused by evaporation and a change in composition of the molten salt.

In the first ion exchange treatment, a time for immersing the glass for chemical strengthening in the first molten salt composition is preferably 30 minutes or longer since the surface compressive stress is increased. The immersion time is more preferably 60 minutes or longer. When the immersion time is too long, the productivity may decrease, and the compressive stress may be reduced due to a relaxation phenomenon. Therefore, the immersion time is generally 360 minutes or shorter.

Note that, the time of the first ion exchange treatment is the above-described t_{CT}, which is a value that can also influence the heat treatment effect index value (I value). Therefore, the time of the first ion exchange treatment may be adjusted in order to set the heat treatment effect index value (I value) to a suitable value.

### (Second Ion Exchange Treatment)

The second ion exchange treatment is preferably a treatment mainly using the “Na—K exchange”. In this case, it is preferable to perform the second ion exchange treatment by immersing the glass for chemical strengthening in a second molten salt composition containing potassium ions. In the second ion exchange treatment mainly using the “Na—K exchange”, sodium ions in the glass are exchanged with potassium ions, and potassium ions are introduced into a region 10 μm or less from the surface layer portion of the glass. In addition, in the case where the second molten salt composition contains a small amount of lithium ions, at the same time, sodium ions in the surface layer portion of the glass are decreased by the “Na—Li exchange”, thereby relaxing the compressive stress caused by sodium. Note that, the influence of the stress on the surface layer portion of the glass into which potassium ions have been introduced is not reflected on the stress profile measured by the SLP. Therefore, by using the stress profile measured by the SLP, it is possible to check a reduction in tensile stress due to a decrease in sodium ions.

A concentration of potassium nitrate in the second molten salt composition is preferably 85 mass % or more, more preferably 90 mass % or more, and still more preferably 95 mass % or more. The upper limit thereof is not particularly limited, and is generally 99.95 mass % or less.

In the case where the second molten salt composition contains lithium ions, the second molten salt composition preferably contains 0.05 mass % or more and 10 mass % or less of lithium nitrate. When the second molten salt composition contains lithium nitrate in the above range, the exchange between the sodium ions introduced near the glass surface in the first ion exchange treatment and the lithium ions in the second molten salt composition occurs in parallel with the exchange of the sodium ions with potassium ions in the second molten salt composition, which can reduce the stress on the glass surface. The content of lithium nitrate in the second molten salt composition is more preferably 0.3 mass % or more and 5 mass % or less.

The second molten salt composition may contain sodium nitrate. When contained, a concentration of sodium nitrate is preferably more than 0.1 mass %, and more preferably 0.5 mass % or more. When the content of sodium nitrate is within the above range, a period during which the effects of the present invention can be exerted can be extended without replacing the second molten salt composition, and the amount of the glass treated can be increased. The concentration of sodium nitrate in the second molten salt composition is preferably 5 mass % or less, more preferably 3 mass % or less, still more preferably 2 mass % or less, and most preferably 1 mass % or less. In this case, it is easy to make the tensile stress of the chemically strengthened glass after the second ion exchange treatment less than the CT limit value.

In the second ion exchange treatment, the glass for chemical strengthening is preferably immersed in the second molten salt composition at a temperature of preferably 360° C. or higher. When the temperature of the second molten salt composition is 360° C. or higher, the ion exchange easily progresses. The temperature is more preferably 380° C. or higher, and still more preferably 400° C. or higher. The temperature of the second molten salt composition is generally 450° C. or lower from the viewpoint of danger caused by evaporation and a change in composition of the molten salt, and is more preferably 440° C. or lower from the viewpoint of preventing an excessive stress reduction due to the “Na—Li exchange”.

In the second ion exchange treatment, when the time for immersing the glass for chemical strengthening in the second molten salt composition is 5 minutes or longer, the sodium ions introduced near the glass surface in the first ion exchange treatment are sufficiently exchanged with the lithium ions in the second molten salt composition, making it easy to reduce the stress on the glass surface. The immersion time is more preferably 30 minutes or longer, and still more preferably 45 minutes or longer. The immersion time is preferably 120 minutes or shorter from the viewpoint of preventing an excessive stress reduction due to heat input to the substrate.

In the present production method, it is preferable that the first ion exchange treatment imparts a tensile stress greater than the CT limit value to the glass for chemical strengthening, and the subsequent second ion exchange treatment lowers the tensile stress to less than the CT limit value. Accordingly, it is possible to increase the compressive stress in a region relatively deep from the surface while preventing the tensile stress from being greater than the CT limit, which contributes to further improving the drop strength of the chemically strengthened glass.

That is, it is preferable that, in the glass for chemical strengthening, a CTave value of the glass for chemical strengthening is made greater than a CTA value [MPa] by the first ion exchange treatment, and the CTave value of the glass for chemical strengthening is made less than the CTA value [MPa] by the second ion exchange treatment, the CTA value [MPa] being determined according to the following equation (1), and the CTave value being determined according to the following equation (2).

$$\begin{matrix}[ Math . 8 ] & \\ CTA = 317.93 \times K 1 c / \sqrt{t} + 228.5 \times t - 398 & Equation ( 1 )\end{matrix}$$

t: sheet thickness [mm]
K1c: fracture toughness value [MPa·m^{1/2}]

$$CTave = ICT / LCT \qquad Equation ( 2 )$$

ICT: tensile stress integrated value [MPa·μm]
LCT: sheet thickness direction length [μm] of tensile stress region

Here, the “fracture toughness value K1c” is a value obtained by the IF method defined in JIS R1607:2015. The value of K1c is a value dependent on the glass composition and can be adjusted according to the glass composition.

The above CTA value is a value corresponding to the CT limit. The CTave value being greater than x [MPa] corresponds to the tensile stress being greater than the CT limit value, and the CTave value being less than x [MPa] corresponds to the tensile stress being less than the CT limit value. Examples of a method of making the CTave value of the glass for chemical strengthening determined according to the above equation (2) greater than x [MPa] by the first ion exchange treatment, and making the CTave value of the glass for chemical strengthening less than x [MPa] by the second ion exchange treatment include 1) a method of appropriately optimizing the treatment conditions in the heat treatment between the first ion exchange treatment and the second ion exchange treatment in the present production method, and 2) an ion exchange treatment method described in WO 2022/181812.

### <Glass for Chemical Strengthening>

In the present production method, a glass for chemical strengthening is chemically strengthened to obtain a chemically strengthened glass. The glass for chemical strengthening in the present production method is preferably a lithium-containing glass, and preferably a lithium aluminosilicate glass. The glass for chemical strengthening in the present production method may be an amorphous glass or a crystallized glass. Note that, a base composition of a chemically strengthened glass according to an embodiment of the present invention matches a composition of the glass for chemical strengthening before chemical strengthening, and when the glass for chemical strengthening is a crystallized glass, the chemically strengthened glass is also a crystallized glass.

In one embodiment, more specific examples of the base composition of the chemically strengthened glass (the composition of the glass for chemical strengthening) include the following glass composition Xa, glass composition Xb, and glass composition Xc. In the case where the chemically strengthened glass is a crystallized glass, the base composition thereof is preferably the glass composition Xc.

Glass composition Xa: a composition containing, in mol % in terms of oxide, 54% to 77% of SiO₂, 9% to 21% of Al₂O₃, and 5% to 16% of Li₂O.

Glass composition Xb: a composition containing, in mol % in terms of oxide, 52% to 75% of SiO₂, 8% to 20% of Al₂O₃, and 5% to 16% of Li₂O.

Glass composition Xc: a composition containing, in mol % in terms of oxide, 40% to 70% of SiO₂, 10% to 35% of Li₂O, and 1% to 15% of Al₂O₃.

Examples of a form of the glass composition Xc include a composition containing, in mol % in terms of oxide,
40% to 70% of SiO₂,
10% to 35% of Li₂O,
1% to 15% of Al₂O₃,
0.5% to 5% of P₂O₅,
0.5% to 5% of ZrO₂,
0% to 10% of B₂O₃,
0% to 3% of Na₂O,
0% to 1% of K₂O, and
0% to 4% of SnO₂.

Examples of another form of the glass composition Xc include a composition containing, in mol % in terms of oxide,
50% to 70% of SiO₂,
15% to 30% of Li₂O,
1% to 10% of Al₂O₃,
0.5% to 5% of P₂O₅,
0.5% to 8% of ZrO₂,
0.1% to 10% of MgO,
0% to 5% of Y₂O₃,
0% to 10% of B₂O₃,
0% to 3% of Na₂O,
0% to 1% of K₂O, and
0% to 2% of SnO₂.

Hereinafter, preferred glass compositions will be described.

In the glass for chemical strengthening in the present embodiment, SiO₂ is a component that forms a network structure of the glass. It is also a component that improves the chemical durability.

In the glass composition Xa, the content of SiO₂ is preferably 54% or more. The content of SiO₂ is more preferably 56% or more, still more preferably 60% or more, particularly preferably 64% or more, and extremely preferably 68% or more. On the other hand, in the glass composition Xa, the content of SiO₂ is preferably 77% or less, more preferably 75% or less, still more preferably 73% or less, and particularly preferably 71% or less in order to improve the meltability.

In the glass composition Xb, the content of SiO₂ is preferably 52% or more. The content of SiO₂ is more preferably 56% or more, still more preferably 60% or more, particularly preferably 64% or more, and extremely preferably 68% or more. On the other hand, in the glass composition Xb, the content of SiO₂ is preferably 75% or less, more preferably 73% or less, still more preferably 71% or less, and particularly preferably 69% or less in order to improve the meltability.

In the glass composition Xc, the content of SiO₂ is preferably 45% or more. The content of SiO₂ is more preferably 48% or more, still more preferably 50% or more, particularly preferably 52% or more, and extremely preferably 54% or more. On the other hand, the content of SiO₂ is preferably 70% or less, more preferably 68% or less, still more preferably 66% or less, and particularly preferably 64% or less in order to improve the meltability.

Al₂O₃ is a component that increases the surface compressive stress due to chemical strengthening and is essential.

In the glass composition Xa, the content of Al₂O₃ is preferably 9% or more, more preferably 10% or more, 11% or more, 12% or more, and 13% or more in order, still more preferably 14% or more, and particularly preferably 15% or more. On the other hand, in the glass composition Xa, the content of Al₂O₃ is preferably 21% or less, more preferably 18% or less, still more preferably 17% or less and 16% or less in order, and most preferably 15% or less in order to prevent the devitrification temperature of the glass from being too high.

In the glass composition Xb, the content of Al₂O₃ is preferably 8% or more, more preferably 10% or more, 11% or more, 12% or more, and 13% or more in order, still more preferably 14% or more, and particularly preferably 15% or more. On the other hand, in the glass composition Xb, the content of Al₂O₃ is preferably 20% or less, more preferably 18% or less, still more preferably 17% or less and 16% or less in order, and most preferably 15% or less in order to prevent the devitrification temperature of the glass from being too high.

In the glass composition Xc, the content of Al₂O₃ is preferably 1% or more, more preferably 2% or more, still more preferably 3% or more, 5% or more, 5.5% or more, and 6% or more in order, particularly preferably 6.5% or more, and most preferably 7% or more. On the other hand, the content of Al₂O₃ is preferably 15% or less, more preferably 12% or less, still more preferably 10% or less, particularly preferably 9% or less, and most preferably 8% or less in order to prevent the devitrification temperature of the glass from being too high.

Li₂O is a component that forms the compressive stress by ion exchange, and is essential since it is a constituent component of a main crystal.

In the glass composition Xa, the content of Li₂O is preferably 5% or more, more preferably 7% or more, and still more preferably 10% or more. On the other hand, in the glass composition Xa, the content of Li₂O is preferably 16% or less, more preferably 15% or less, still more preferably 14% or less, and most preferably 12% or less in order to stabilize the glass.

In the glass composition Xb, the content of Li₂O is preferably 5% or more, more preferably 7% or more, and still more preferably 10% or more. On the other hand, in the glass composition Xb, the content of Li₂O is preferably 16% or less, more preferably 15% or less, still more preferably 14% or less, and most preferably 12% or less in order to stabilize the glass.

In the glass composition Xc, the content of Li₂O is preferably 10% or more, more preferably 14% or more, still more preferably 15% or more, even more preferably 18% or more, particularly preferably 20% or more, and most preferably 22% or more. On the other hand, the content of Li₂O is preferably 35% or less, more preferably 32% or less, still more preferably 30% or less, particularly preferably 28% or less, and most preferably 26% or less in order to stabilize the glass.

Na₂O is a component that improves the meltability of the glass.

In the glass composition Xa, Na₂O is not essential, but in the case where it is contained, the content thereof is preferably 0.5% or more, more preferably 0.8% or more, and particularly preferably 1% or more. When the content of Na₂O is too large, crystals are less likely to precipitate or the chemical strengthening properties deteriorate, and therefore, the content of Na₂O is preferably 10% or less, more preferably 8% or less, and particularly preferably 6% or less.

In the glass composition Xb, Na₂O is not essential, but in the case where it is contained, the content thereof is preferably 1% or more, more preferably 2% or more, and particularly preferably 5% or more. When the content of Na₂O is too large, crystals are less likely to precipitate or the chemical strengthening properties deteriorate, and therefore, the content of Na₂O is preferably 15% or less, more preferably 12% or less, and particularly preferably 10% or less.

In the glass composition Xc, Na₂O is not essential, but in the case where it is contained, the content thereof is preferably 0.5% or more, more preferably 1% or more, and particularly preferably 2% or more. When the content of Na₂O is too large, crystals such as Li₃PO₄, which is a main crystal, are less likely to precipitate or the chemical strengthening properties deteriorate, and therefore, the content of Na₂O is preferably 10% or less, more preferably 9% or less, still more preferably 8% or less, and particularly preferably 7% or less.

K₂O is a component that lowers the melting temperature of the glass and may be contained, similar to Na₂O.

In the glass composition Xa, in the case where K₂O is contained, the content thereof is preferably 0.5% or more, more preferably 0.8% or more, and still more preferably 1% or more. When the content of K₂O is too large, the chemical strengthening properties deteriorate or the chemical durability decreases, and therefore, the content thereof is preferably 5% or less, more preferably 4% or less, still more preferably 3% or less, particularly preferably 2.5% or less, and most preferably 2% or less.

In the glass composition Xb, in the case where K₂O is contained, the content thereof is preferably 0.5% or more, more preferably 0.8% or more, and still more preferably 1% or more. When the content of K₂O is too large, the chemical strengthening properties deteriorate or the chemical durability decreases, and therefore, the content thereof is preferably 10% or less, more preferably 8% or less, still more preferably 6% or less, particularly preferably 4% or less, and most preferably 2% or less.

In the glass composition Xc, in the case where K₂O is contained, the content thereof is preferably 0.5% or more, more preferably 1% or more, still more preferably 1.5% or more, and particularly preferably 2% or more. When the content of K₂O is too large, the chemical strengthening properties deteriorate or the chemical durability decreases, and therefore, the content thereof is preferably 5% or less, more preferably 4% or less, still more preferably 3% or less, particularly preferably 2% or less, and most preferably 1% or less.

In the glass composition Xa, the total content of Na₂O and K₂O, that is, Na₂O+K₂O, is preferably 2% or more, and more preferably 3% or more, in order to improve the meltability of the glass raw material. In addition, a ratio of the content of K₂O to the total content of Li₂O, Na₂O, and K₂O (hereinafter, R₂O), that is, K₂O/R₂O, is preferably 0.2 or less since the chemical strengthening properties can be improved and the chemical durability can be improved. The K₂O/R₂O is more preferably 0.17 or less, and still more preferably 0.15 or less. R₂O is preferably 10% or more, more preferably 12% or more, and still more preferably 14% or more. In addition, R₂O is preferably 20% or less, and more preferably 18% or less.

In the glass composition Xb, the total content of Na₂O and K₂O, that is, Na₂O+K₂O, is preferably 3% or more, and more preferably 5% or more, in order to improve the meltability of the glass raw material. In addition, the ratio of the content of K₂O to the total content of Li₂O, Na₂O, and K₂O (hereinafter, R₂O), that is, K₂O/R₂O, is preferably 0.2 or less since the chemical strengthening properties can be improved and the chemical durability can be improved. The K₂O/R₂O is more preferably 0.15 or less, and still more preferably 0.10 or less. Note that, R₂O is preferably 10% or more, more preferably 12% or more, and still more preferably 15% or more. In addition, R₂O is preferably 20% or less, and more preferably 18% or less.

In the glass composition Xc, the total content of Na₂O and K₂O, that is, Na₂O+K₂O, is preferably 1% or more, and more preferably 2% or more, in order to improve the meltability of the glass raw material. In addition, the ratio of the content of K₂O to the total content of Li₂O, Na₂O, and K₂O (hereinafter, R₂O), that is, K₂O/R₂O, is preferably 0.2 or less since the chemical strengthening properties can be improved and the chemical durability can be improved. The K₂O/R₂O is more preferably 0.15 or less, and still more preferably 0.10 or less. R₂O is preferably 10% or more, more preferably 15% or more, and still more preferably 20% or more. In addition, R₂O is preferably 29% or less, and more preferably 26% or less.

In the glass composition Xa and the glass composition Xb, P₂O₅ is a component that deepens the compressive stress layer by chemical strengthening, and may be contained. The content of P₂O₅ is preferably 0.5% or more, more preferably 1% or more, still more preferably 1.5% or more, particularly preferably 2% or more, and extremely preferably 2.5% or more in order to deepen the compressive stress layer.

On the other hand, when the content of P₂O₅ is too large, the phase separation is likely to occur during melting and the acid resistance remarkably decreases, and therefore, the content of P₂O₅ is preferably 5% or less, more preferably 4.8% or less, still more preferably 4.5% or less, and particularly preferably 4.2% or less.

In the glass composition Xc, P₂O₅ is a constituent component of a Li₃PO₄ crystal and is essential. The content of P₂O₅ is preferably 0.5% or more, more preferably 1% or more, still more preferably 1.5% or more, particularly preferably 2% or more, and extremely preferably 2.5% or more in order to promote the crystallization. On the other hand, when the content of P₂O₅ is too large, the phase separation is likely to occur during melting and the acid resistance remarkably decreases, and therefore, the content of P₂O₅ is preferably 5% or less, more preferably 4.8% or less, still more preferably 4.5% or less, and particularly preferably 4.2% or less.

SiO₂, Al₂O₃, P₂O₅, and B₂O₃ are network forming components (hereinafter also abbreviated as NWF) of the glass, and when the total amount of NWF is large, the strength of the crystallized glass is improved. Accordingly, the fracture toughness value of the crystallized glass is increased. From such a viewpoint, in the glass composition Xc, the total amount of NWF is preferably 60% or more, more preferably 63% or more, and particularly preferably 65% or more. However, a glass containing too much NWF has a high melting temperature and is difficult to produce, and therefore, the total amount of NWF is preferably 85% or less, more preferably 80% or less, and still more preferably 75% or less.

In the glass composition Xc, a ratio of the total amount of Li₂O, Na₂O, and K₂O to the total amount of NWF, that is, SiO₂, Al₂O₃, P₂O₅, and B₂O₃ is preferably 0.20 to 0.60. Li₂O, Na₂O, and K₂O are network modifying components, and decreasing the ratio to NWF increases gaps in the network, and therefore, the impact resistance is improved. Therefore, the ratio to NWF is preferably 0.60 or less, more preferably 0.55 or less, and particularly preferably 0.50 or less. On the other hand, since these components are necessary for chemical strengthening, the ratio of the total amount of Li₂O, Na₂O, and K₂O to NWF is preferably 0.20 or more, more preferably 0.25 or more, and particularly preferably 0.30 or more in order to improve the chemical strengthening properties.

ZrO₂ is a component that improves the mechanical strength and the chemical durability, and is preferably contained in order to remarkably increase the CS. The content of ZrO₂ is preferably 0.5% or more, more preferably 1% or more, still more preferably 1.5% or more, particularly preferably 2% or more, and most preferably 2.5% or more.

On the other hand, the content of ZrO₂ is preferably 8% or less, more preferably 7.5% or less, still more preferably 7% or less, and particularly preferably 6% or less in order to prevent the devitrification during melting. When the content of ZrO₂ is too large, the devitrification temperature rises and thereby the viscosity decreases. In the case where the forming viscosity is low, the content of ZrO₂ is preferably 5% or less, more preferably 4.5% or less, and still more preferably 3.5% or less in order to prevent deterioration of the formability due to such a decrease in viscosity.

The ZrO₂/R₂O is preferably 0.02 or more, more preferably 0.04 or more, still more preferably 0.06 or more, particularly preferably 0.08 or more, and most preferably 0.1 or more in order to improve the chemical durability. The ZrO₂/R₂O is preferably 0.2 or less, more preferably 0.18 or less, still more preferably 0.16 or less, and particularly preferably 0.14 or less in order to improve the transparency after crystallization.

MgO is a component that stabilizes the glass and is also a component that improves the mechanical strength and the chemical resistance, and is thus preferably contained in the case where the content of Al₂O₃ is small. The content of MgO is preferably 1% or more, more preferably 2% or more, still more preferably 3% or more, and particularly preferably 4% or more.

On the other hand, when too many MgO is added, the viscosity of the glass is lowered, and the devitrification or the phase separation is likely to occur. The content of MgO is preferably 20% or less, more preferably 19% or less, still more preferably 18% or less, and particularly preferably 17% or less.

TiO₂ is a component capable of promoting the crystallization and may be contained. TiO₂ is not essential, but in the case where it is contained, the content thereof is preferably 0.05% or more, and more preferably 0.1% or more. On the other hand, the content of TiO₂ is preferably 1% or less, more preferably 0.5% or less, and still more preferably 0.3% or less in order to prevent the devitrification during melting.

SnO₂ has an effect of promoting generation of a crystal nucleus and may be contained. SnO₂ is not essential, and but in the case where it is contained, the content thereof is preferably 0.5% or more, more preferably 1% or more, still more preferably 1.5% or more, and particularly preferably 2% or more. On the other hand, the content of SnO₂ is preferably 4% or less, more preferably 3.5% or less, still more preferably 3% or less, and particularly preferably 2.5% or less in order to prevent the devitrification during melting.

Y₂O₃ is a component that has an effect of preventing fragments from scattering when the chemically strengthened glass is broken, and may be contained. The content of Y₂O₃ is preferably 0.2% or more, more preferably 0.5% or more, still more preferably 1% or more, particularly preferably 2% or more, and extremely preferably 3% or more. On the other hand, the content of Y₂O₃ is preferably 5% or less, and more preferably 4% or less in order to prevent the devitrification during melting.

B₂O₃ is a component that improves the chipping resistance of the glass for chemical strengthening or the chemically strengthened glass and that improves the meltability, and may be contained. In the case where B₂O₃ is contained, the content thereof is preferably 0.5% or more, more preferably 1% or more, and still more preferably 2% or more in order to improve the meltability. On the other hand, when the content of B₂O₃ is too large, striae may be generated during melting or the phase separation is likely to occur, and the quality of the glass for chemical strengthening is likely to decrease, so that the content thereof is preferably 10% or less. The content of B₂O₃ is more preferably 8% or less, still more preferably 6% or less, and particularly preferably 4% or less.

BaO, SrO, MgO, CaO, and ZnO are all components that improve the meltability of the glass, and may be contained.

Among them, BaO, SrO, and ZnO may be contained in the glass composition Xc in order to increase a refractive index of a residual glass to be close to a precipitated crystal phase, thereby increasing a light transmittance and decreasing a haze value of the crystallized glass. In this case, the total content of BaO, SrO, and ZnO (hereinafter, BaO+SrO+ZnO) is preferably 0.3% or more, more preferably 0.5% or more, still more preferably 0.7% or more, and particularly preferably 1% or more. On the other hand, these components may decrease the ion exchange rate. The BaO+SrO+ZnO is preferably 2.5% or less, more preferably 2% or less, still more preferably 1.7% or less, and particularly preferably 1.5% or less in order to improve the chemical strengthening properties.

La₂O₃, Nb₂O₅, and Ta₂O₅ are all components that prevent fragments from scattering when the chemically strengthened glass is broken, and may be contained in order to increase the refractive index. In the case where these components are contained, the total content of La₂O₃, Nb₂O₅, and Ta₂O₅ (hereinafter, La₂O₃+Nb₂O₅+Ta₂O₅) is preferably 0.5% or more, more preferably 1% or more, still more preferably 1.5% or more, and particularly preferably 2% or more. In addition, the La₂O₃+Nb₂O₅+Ta₂O₅ is preferably 4% or less, more preferably 3% or less, still more preferably 2% or less, and particularly preferably 1% or less in order to prevent the devitrification of the glass during melting.

In addition, CeO₂ may be contained. CeO₂ may prevent coloring by causing oxidation of the glass. In the case where CeO₂ is contained, the content thereof is preferably 0.03% or more, more preferably 0.05% or more, and still more preferably 0.07% or more. The content of CeO₂ is preferably 1.5% or less, and more preferably 1.0% or less in order to improve the transparency.

When the chemically strengthened glass is colored and used, a coloring component may be added within a range that does not impede achievement of desired chemical strengthening properties. Examples of the coloring component include Co₃O₄, MnO₂, Fe₂O₃, NiO, CuO, Cr₂O₃, V₂O₅, Bi₂O₃, SeO₂, Er₂O₃, and Nd₂O₃.

The total content of the coloring component is preferably in a range of 1% or less. When it is desired to further increase a visible light transmittance of the glass, these components are preferably not substantially contained.

HfO₂, Nb₂O₅, and Ti₂O₃ may be added in order to improve the weather resistance against ultraviolet light irradiation. In the case where HfO₂, Nb₂O₅, and Ti₂O₃ are added for the purpose of improving the weather resistance against ultraviolet light irradiation, the total content thereof is preferably 1% or less, more preferably 0.5% or less, and still more preferably 0.1% or less in order to reduce influences on other properties.

SO₃, a chloride, and a fluoride may be appropriately contained as a refining agent or the like during melting of the glass. The total content of components that function as a refining agent is, in mass % in terms of oxide, preferably 2% or less, more preferably 1% or less, and still more preferably 0.5% or less since the strengthening properties and the crystallization behavior may be influenced when added too much. The lower limit thereof is not particularly limited, and is typically preferably 0.05% or more in mass % in terms of oxide.

In the case where SO₃ is used as the refining agent, the content of SO₃ is, in mass % in terms of oxide, preferably 0.01% or more, more preferably 0.05% or more, and still more preferably 0.1% or more since the effect cannot be obtained when the content is too small. In addition, in the case where SO₃ is used as the refining agent, the content of SO₃ is, in mass % in terms of oxide, preferably 1% or less, more preferably 0.8% or less, and still more preferably 0.6% or less.

In the case where Cl is used as the refining agent, the content of Cl is, in mass % in terms of oxide, preferably 1% or less, more preferably 0.8% or less, and still more preferably 0.6% or less since physical properties such as the strengthening properties may be influenced when added too much. In addition, in the case where Cl is used as the refining agent, the content of Cl is, in mass % in terms of oxide, preferably 0.05% or more, more preferably 0.1% or more, and still more preferably 0.2% or more since the effect cannot be obtained when the content is too small.

In the case where SnO₂ is used as the refining agent, the content of SnO₂ is, in mass % in terms of oxide, preferably 1% or less, more preferably 0.5% or less, and still more preferably 0.3% or less since the crystallization behavior may be influenced when added too much. In addition, in the case where SnO₂ is used as the refining agent, the content of SnO₂ is, in mass % in terms of oxide, preferably 0.02% or more, more preferably 0.05% or more, and still more preferably 0.1% or more since the effect cannot be obtained when the content is too small.

As₂O₃ is preferably not contained. In the case where As₂O₃ is contained, the content thereof is preferably 0.3% or less, and more preferably 0.1% or less, and it is most preferable that As₂O₃ is not contained.

The composition of the glass for chemical strengthening to be used for chemical strengthening according to the present invention is as described above.

In order to obtain a glass having the above composition, the glass raw materials are appropriately mixed, and heated and melted in a glass melting furnace. Thereafter, the molten glass is homogenized by bubbling, stirring, addition of a refining agent, and the like, and formed into a glass sheet having a predetermined thickness, followed by annealing. Alternatively, the molten glass may be formed into a block shape, annealed, and then formed into a sheet shape by a cutting method.

Examples of the method for forming the glass into a sheet shape include a float method, a press method, a fusion method, and a down-draw method. The float method is particularly preferred in the case of producing a large glass sheet. As a continuous forming method other than the float method, for example, a fusion method and a down-draw method are also preferred.

The glass for chemical strengthening may be a crystallized glass. In the case of a crystallized glass, a crystallized glass including 1 or more crystals selected from the group consisting of a lithium silicate crystal, a lithium aluminosilicate crystal, and a lithium phosphate crystal is preferred. The lithium silicate crystal is preferably a lithium metasilicate crystal, a lithium disilicate crystal, or the like. The lithium phosphate crystal is preferably a lithium orthophosphate crystal or the like. The lithium aluminosilicate crystal is preferably a β-spodumene crystal, a petalite crystal, or the like.

The crystallization rate of the crystallized glass is preferably 10% or more, more preferably 15% or more, still more preferably 20% or more, and particularly preferably 25% or more in order to improve the mechanical strength. The crystallization rate of the crystallized glass is preferably 70% or less, more preferably 60% or less, and particularly preferably 50% or less in order to improve the transparency. A low crystallization rate is also excellent in that the glass is easily bent by heating. The crystallization rate can be calculated based on the X-ray diffraction intensity by using the Rietveld method. The Rietveld method is described in “Crystal Analysis Handbook” edited by the Crystallographic Society of Japan Editing Committee of “Crystal Analysis Handbook” (Kyoritsu Shuppan, 1999, p 492 to 499).

The average particle diameter of precipitated crystals of the crystallized glass is preferably 300 nm or less, more preferably 200 nm or less, still more preferably 150 nm or less, and particularly preferably 100 nm or less in order to improve the transparency. The average particle diameter of the precipitated crystals can be determined from a transmission electron microscope (TEM) image. It can also be estimated from a scanning electron microscope (SEM) image.

### <Chemically Strengthened Glass>

A chemically strengthened glass according to an embodiment of the present invention (hereinafter, also referred to as “the present chemically strengthened glass”) is obtained by the present production method described above. That is, the present chemically strengthened glass has a relatively larger CS₉₀ value with respect to the total compressive stress introduced into the chemically strengthened glass. Accordingly, the present chemically strengthened glass has excellent set drop strength.

Here, it known that, in a set drop strength test, the stress at a certain depth from the glass surface is effective particularly for an evaluation surface having large surface roughness such as sandpaper. Specifically, in the case where the evaluation surface is sandpaper having a grit count of 60 to 100, the set drop strength has a positive correlation with the stress at a depth of 90 μm from the surface. In addition, in the case where the evaluation surface is sandpaper having a grit count of 100 to 140, the set drop strength has a positive correlation with the stress at a depth of 70 μm from the surface. Further, in the case where the evaluation surface is sandpaper having a grit count of 160 to 200, the set drop strength has a positive correlation with the stress at a depth of 50 μm from the surface.

That is, a large CS₉₀ value particularly contributes to improving the “SP #80 drop strength” among the set drop strength. Therefore, the present chemically strengthened glass is particularly excellent in “SP #80 drop strength”.

### First Embodiment

A chemically strengthened glass according to a first embodiment of the present invention is a chemically strengthened glass having a thickness t [mm], in which a compressive stress layer depth DOC [μm] is 160t [μm] or more, and a value CS₉₀/ICT [μm⁻¹] obtained by dividing CS₉₀ [MPa] which is a compressive stress value at a depth of 90 μm from a surface by a tensile stress integrated value ICT [MPa·μm] is 0.0012 μm⁻¹ or more.

A relatively large CS₉₀/ICT value means that the CS₉₀ value is relatively larger with respect to the total compressive stress introduced into the chemically strengthened glass. That is, the larger the CS₉₀/ICT value is, the more the chemically strengthened glass has an increased CS₉₀ and the drop strength can be improved as compared with the case where the same degree of compressive stress is introduced.

The glass obtained by the present production method has a relatively large DOC. Accordingly, the present chemically strengthened glass has the compressive stress introduced to a deeper portion thereof, and has excellent drop strength. Specifically, in the present embodiment, the DOC is 160t [μm] or more.

The CS₉₀/ICT [μm⁻¹] is 0.0012 μm⁻¹ or more, preferably 0.0013 μm⁻¹ or more, more preferably 0.0014 μm⁻¹ or more, still more preferably 0.0015 μm⁻¹ or more, and particularly preferably 0.0016 μm⁻¹ or more. On the other hand, the CS₉₀/ICT [μm⁻¹] is preferably 0.0050 μm⁻¹ or less, more preferably 0.0048 μm⁻¹ or less, still more preferably 0.0045 μm⁻¹ or less, particularly preferably 0.0042 μm⁻¹ or less, and most preferably 0.0040 μm⁻¹ or less, from the viewpoint of a balance with the strength other than the set drop strength.

The DOC is 160t [μm] or more, preferably 165t [μm] or more, more preferably 170t [μm] or more, still more preferably 180t [μm] or more, and most preferably 190t [μm] or more, with the thickness of the chemically strengthened glass being t [mm]. On the other hand, the DOC is preferably 350t [μm] or less, more preferably 300t [μm] or less, still more preferably 280t [μm] or less, particularly preferably 250t [μm] or less, and most preferably 240t [μm] or less, from the viewpoint of a decrease in productivity due to a longer treatment time.

A larger CS₉₀ is preferred from the viewpoint of improving the drop strength, and a preferred value differs depending on the value of the sheet thickness t [mm]. The CS₉₀ is preferably 5+50t [MPa] or more, more preferably 7+50t [MPa] or more, still more preferably 8+50t [MPa] or more, and particularly preferably 9+50t [MPa] or more. On the other hand, the CS₉₀ is preferably −85+250t [MPa] or less, more preferably −83+250t [MPa] or less, still more preferably −84+250t [MPa] or less, particularly preferably −83+250t [MPa] or less, from the viewpoint of a balance with the strength other than the set drop strength.

A value DOC/CS₅₀ obtained by dividing the DOC by CS₅₀ [MPa] which is a compressive stress value at a depth of 50 μm from the surface is preferably 0.8 μm/MPa or more, more preferably 0.83 μm/MPa or more, still more preferably 0.85 μm/MPa or more, particularly preferably 0.87 μm/MPa or more, and most preferably 0.9 μm/MPa or more. A relatively large DOC/CS₅₀ means that the DOC is larger in comparison with the case where the CS₅₀ is equivalent. Accordingly, it is preferred since the stress can be introduced into a deeper layer and high set drop strength can be obtained. On the other hand, the DOC/CS₅₀ is preferably 2.0 μm/MPa or less, more preferably 1.8 μm/MPa or less, still more preferably 1.6 μm/MPa or less, particularly preferably 1.5 μm/MPa or less, and most preferably 1.4 μm/MPa or less, from the viewpoint of the balance between a deep stress and a surface stress.

A value CS₉₀/CS₅₀ obtained by dividing the CS₉₀ by the CS₅₀ [MPa] which is the compressive stress value at a depth of 50 μm from the surface is preferably 0.30 or more, more preferably 0.31 or more, still more preferably 0.32 or more, particularly preferably 0.35 or more, and most preferably 0.40 or more. A relatively large CS₉₀/CS₅₀ means that the CS₉₀ is larger in comparison with the case where the CS₅₀ is equivalent. Accordingly, it is particularly preferred since the SP #80 drop strength can be improved. On the other hand, the CS₉₀/CS₅₀ is preferably 2.0 or less, more preferably 1.8 or less, still more preferably 1.6 or less, particularly preferably 1.5 or less, and most preferably 1.2 or less, from the viewpoint of a balance with the SP #180 drop strength.

In a profile of a stress value CSₓ [MPa] at a depth x [μm] from the glass surface as measured with a scattered light photoelastic stress meter, the absolute value |CSₓ′| of a first-order differential value of the stress CSₓ in a range of CSₓ≥0 is preferably less than 4, more preferably 3.5 or less, still more preferably 3.0 or less, particularly preferably 2.8 or less, and most preferably 2.6 or less. A relatively small |CSₓ′| means that the profile has a gentle shape and has a stable stress value throughout the deep layer. That is, it is preferable that the CSₓ′ is within the above range since a high stress and high set drop strength can be obtained on the deep layer side. On the other hand, the |CSₓ′| is preferably 0.05 or more, more preferably 0.1 or more, still more preferably 0.2 or more, particularly preferably 0.3 or more, and most preferably 0.5 or more, from the viewpoint of a balance between the compressive stress and the tensile stress.

In the profile of the stress value CSₓ [MPa] at a depth x [μm] from the glass surface as measured with a scattered light photoelastic stress meter, a second-order differential value CSₓ″ of the stress value CSₓ in a range of CSₓ≥0 is preferably −0.02 to 0.06. The CSₓ″ is preferably 0.06 or less, more preferably 0.057 or less, still more preferably 0.055 or less, particularly preferably 0.052 or less, and most preferably 0.050 or less. On the other hand, the CSₓ″ is preferably −0.02 or more, more preferably 0.000 or more, still more preferably 0.010 or more, particularly preferably 0.015 or more, and most preferably 0.020 or more. The closer the CSₓ″ value is to 0 (the smaller the absolute value), the more linear the stress profile is, and the CS₉₀ which is the stress value at a depth of 90 μm can be effectively increased. The CSₓ′ may be 0, that is, the stress profile may have an inflection point. A stress profile having an inflection point in a deep layer portion is preferred from the viewpoint that the tensile stress CT can be particularly reduced, so that it is easy to make the CT less than the CT limit value. On the other hand, the CSₓ″ may take a positive value and the stress profile may not have an inflection point. A profile without an inflection point is preferred in that there is no local stress drop, which prevents the propagation of cracks generated from the glass surface layer.

As a method for differentiating a stress profile, in the present invention, as represented by the following equations, in a CSₓ profile, a rate of change in CSₓ when an amount of change in x is 0.5 μm is used as the value CSₓ′, and a rate of change in CSₓ′ when the amount of change in x is 0.5 μm is used as the value CSₓ″.

$${{CS}_{x}}^{′} = ( {CS}_{x + 0.5} - {CS}_{x} ) / 0.5$$

$${{CS}_{x}}^{″} = ( {{CS}_{x + 0.5}}^{′} - {{CS}_{x}}^{′} ) / 0.5$$

A surface compressive stress value CS₀ as measured with a film stress measurement is preferably 750 MPa or more, more preferably 780 MPa or more, still more preferably 800 MPa or more, particularly preferably 850 MPa or more, and most preferably 900 MPa or more, from the viewpoint of increasing the surface layer compressive stress and improving the strength against deformation such as bending. On the other hand, the CS₀ is preferably 2500 MPa or less, more preferably 2000 MPa or less, still more preferably 1800 MPa or less, particularly preferably 1600 MPa or less, and most preferably 1400 MPa or less, from the viewpoint of preventing the occurrence of severe crushing in the case of cracks.

CS₁ [MPa] which is a compressive stress value at a depth of 1 μm from the glass surface as measured with a film stress measurement is preferably 550 MPa or more, more preferably 560 MPa or more, still more preferably 580 MPa or more, particularly preferably 600 MPa or more, and most preferably 650 MPa or more, from the viewpoint of preventing further opening of tips of fine scratches present on the glass surface. On the other hand, the CS₁ is preferably 1000 MPa or less, more preferably 950 MPa or less, still more preferably 900 MPa or less, particularly preferably 850 MPa or less, and most preferably 800 MPa or less, from the viewpoint of preventing scattering of fine fragments in the case of cracks.

A surface compressive stress layer depth DOL-tail [μm] as measured with a film stress measurement is preferably 2.8 μm or more, more preferably 3.0 μm or more, still more preferably 3.1 μm or more, particularly preferably 3.3 μm or more, and most preferably 3.5 μm or more, from the viewpoint of preventing cracks due to collision. On the other hand, the DOL-tail [μm] is preferably 10.0 μm or less, more preferably 9.0 μm or less, still more preferably 8.5 μm or less, particularly preferably 8.0 μm or less, and most preferably 7.5 μm or less, in order to balance the total amount of the tensile stress and the compressive stress in the entire thickness direction of the glass.

The CS₅₀ [MPa] which is the compressive stress value at a depth of 50 μm from the glass surface is preferably 90 MPa or more, more preferably 95 MPa or more, still more preferably 100 MPa or more, particularly preferably 105 MPa or more, and most preferably 110 MPa or more, from the viewpoint of improving the drop strength. On the other hand, the CS₅₀ is preferably 300 MPa or less, more preferably 250 MPa or less, still more preferably 200 MPa or less, particularly preferably 180 MPa or less, and most preferably 160 MPa or less, from the viewpoint of preventing scattering of fine fragments during crush caused by excessive introduction of energy by stress. Note that a large CS₅₀ value particularly contributes to improving the “SP #180 drop strength” among the set drop strength.

A value CS₅₀/ICT [m⁻¹] obtained by dividing the CS₅₀ [MPa] which is the compressive stress value at a depth of 50 μm from the surface by the tensile stress integrated value ICT [MPa·μm] is preferably 0.0037 μm⁻¹ or more, more preferably 0.0039 μm⁻¹ or more, still more preferably 0.0040 μm⁻¹ or more, particularly preferably 0.0042 μm⁻¹ or more, and most preferably 0.0043 μm⁻¹ or more, from the viewpoint of improving the drop strength. On the other hand, the CS₅₀/ICT [μm⁻¹] is preferably 0.0100 μm⁻¹ or less, more preferably 0.0090 μm⁻¹ or less, still more preferably 0.0080 μm⁻¹ or less, particularly preferably 0.0060 μm⁻¹ or less, and most preferably 0.0050 μm⁻¹ or less, from the viewpoint of a balance with a strength other than the drop strength.

CT-Max [MPa] represents the maximum tensile stress value in the stress profile. The CT-Max is preferably 170-150t [MPa] or more, more preferably 172-150t [MPa] or more, still more preferably 175-150t [MPa] or more, and particularly preferably 180-150t [MPa] or more in the case of the thickness t [mm], from the viewpoint of achieving excellent set drop strength. On the other hand, the CT-Max is preferably 157.5-75t [MPa] or less, more preferably 152.5-75t [MPa] or less, still more preferably 150-75t [MPa] or less, particularly preferably 148-75t [MPa] or less, and most preferably 146-75t [MPa] or less, from the viewpoint of preventing scattering of fine fragments during crush caused by excessive introduction of stress energy.

The CTave [MPa] corresponds to a tensile stress average value determined by the above-described method. The CTave is preferably 107.5-75t [MPa] or more, more preferably 110-75t [MPa] or more, still more preferably 112.5-75t [MPa] or more, and particularly preferably 115-75t [MPa] or more in the case of the thickness t [mm], from the viewpoint of achieving excellent set drop strength. On the other hand, the CTave is preferably 127.5-75t [MPa] or less, more preferably 125-75t [MPa] or less, particularly preferably 122.5-75t [MPa] or less, and most preferably 120-75t [MPa] or less, from the viewpoint of preventing scattering of fine fragments during crush caused by excessive introduction of stress energy.

The ICT [MPa·μm] represents a tensile stress integrated value up to half the sheet thickness. The ICT is preferably 250+17500t [MPa·μm] or more, more preferably 300+17500t [MPa·μm] or more, still more preferably 350+17500t [MPa·μm] or more, and particularly preferably 400+17500t [MPa·μm] or more in the case of the thickness t [mm], from the viewpoint of achieving excellent set drop strength. On the other hand, the ICT is preferably 4000+20000t [MPa·μm] or less, more preferably 3950+20000t [MPa·μm] or less, still more preferably 3900+20000t [MPa·μm] or less, particularly preferably 3850+20000 [MPa·μm] or less, and most preferably 3800+20000t [MPa·μm] or less, from the viewpoint of preventing scattering of fine fragments during crush caused by excessive introduction of stress energy.

### Second Embodiment

A chemically strengthened glass according to a second embodiment of the present invention is a chemically strengthened glass having a thickness t [mm], in which an Na ion diffusion depth determined based on an Na ion concentration profile in a sheet thickness direction of the chemically strengthened glass measured by an electron probe micro analyzer is 290t [μm] or more, and a ratio ΔNa90/ΔNa50 is 0.55 or more, where the ΔNa50 [mol %] is a difference between an Na₂O concentration in a base composition of the chemically strengthened glass and an Na₂O concentration at a depth of 50 μm from a surface, and the ΔNa90 [mol %] is a difference between the Na₂O concentration in the base composition of the chemically strengthened glass and an Na₂O concentration at a depth of 90 μm from the surface. As described above using FIGS. 1 and 2, the glass obtained by the present production method has a relatively large CS₉₀ and DOC, and correspondingly, the Na ion diffusion depth and the Na₂O concentration at a depth of 90 μm from the surface are also relatively large. The chemically strengthened glass according to the second embodiment of the present invention has excellent set drop strength, particularly SP #80 drop strength, as the Na ion diffusion depth is 290t [μm] or more and the ΔNa90/ΔNa50 is 0.55 or more.

The method for measuring the Na ion concentration profile in the sheet thickness direction of the chemically strengthened glass by using an electron probe micro analyzer is as described above. The Na ion diffusion depth is determined by calculating an average value μ and a standard deviation a of the counts in a range of ±50 μm from a center of the sheet thickness of the acquired Na ion profile in the sheet thickness direction, and is a value at a position closest to the substrate surface where the count is μ+3σ or more.

The Na ion diffusion depth [μm] is preferably 290t [μm] or more, more preferably 330t [μm] or more, still more preferably 360t [μm] or more, particularly preferably 400t [μm] or more, and most preferably 430t [μm] or more, with the thickness of the chemically strengthened glass being t [mm], from the viewpoint of introducing a compressive stress to a deep layer and improving the drop strength. On the other hand, the Na ion diffusion depth is preferably 500t [μm] or less, more preferably 480t [am] or less, still more preferably 470t [μm] or less, particularly preferably 460t [μm] or less, and most preferably 450t [μm] or less, from the viewpoint of preventing deterioration of a molten salt due to many times of ion exchange.

The ratio ΔNa90/ΔNa50 is preferably 0.55 or more, more preferably 0.60 or more, still more preferably 0.70 or more, particularly preferably 0.80 or more, and most preferably 0.90 or more, from the viewpoint of improving the drop strength, where the ΔNa50 [mol %] is a difference between an Na₂O concentration in a base composition of the chemically strengthened glass and an Na₂O concentration at a depth of 50 μm from a surface, and the ΔNa90 [mol %] is a difference between the Na₂O concentration in the base composition of the chemically strengthened glass and an Na₂O concentration at a depth of 90 μm from the surface. On the other hand, the ΔNa90/ΔNa50 is preferably 2.0 or less, more preferably 1.5 or less, still more preferably 1.3 or less, particularly preferably 1.2 or less, and most preferably 1.0 or less, from the viewpoint of a balance with the surface layer stress.

A ratio of the ΔNa90 [mol %] to the Na₂O concentration [mol %] in the base composition of the chemically strengthened glass is preferably 1.26 or more, more preferably 1.27 or more, still more preferably 1.28 or more, particularly preferably 1.29 or more, and most preferably 1.30 or more, from the viewpoint of improving the drop strength. On the other hand, such a ratio is preferably 2.0 or less, more preferably 1.8 or less, still more preferably 1.7 or less, particularly preferably 1.6 or less, and most preferably 1.5 or less, from the viewpoint of a balance with the surface layer stress.

The present chemically strengthened glass may be the chemically strengthened glass according to the first embodiment, or may be the chemically strengthened glass according to the second embodiment. That is, a more preferred form of the chemically strengthened glass according to the second embodiment is the same as a preferred form of the chemically strengthened glass according to the first embodiment. In addition, the chemically strengthened glass according to the first embodiment may have preferred forms of the chemically strengthened glass according to the second embodiment.

Hereinafter, preferred forms common to the chemically strengthened glasses according to the first embodiment and the second embodiment will be further described.

The present chemically strengthened glass has set drop strength (SP #180 drop strength) of preferably 60 cm or more, more preferably 65 cm or more, still more preferably 70 cm or more, and most preferably 75 cm or more, as measured by a sandpaper set drop strength test under the following conditions. When the set drop strength is 60 cm or more, excellent strength is exhibited when the glass is used as a product.

Conditions: an electronic device mounted with the chemically strengthened glass, or an electronic device simulating structure, in which the chemically strengthened glass and a casing for holding the chemically strengthened glass are integrated with each other, is dropped from a height of 30 cm onto #180 sandpaper. When the chemically strengthened glass does not crack, a drop height is increased by 5 cm and dropping is performed again. As long as the chemically strengthened glass does not crack after dropping, a step of dropping from a height increased by 5 cm is repeated. A height at which the chemically strengthened glass first cracks is defined as a crack height. The drop test is performed by using 10 samples, and an average crack height of the 10 samples is set as the set drop strength.

The present chemically strengthened glass has set drop strength (SP #80 drop strength) of preferably 40.5 cm or more, more preferably 41.0 cm or more, still more preferably 42.0 cm or more, and most preferably 45.0 cm or more, as measured by a sandpaper set drop strength test under the following conditions. When the set drop strength is 40.5 cm or more, excellent strength is exhibited when the glass is used as a product. In addition, when the present chemically strengthened glass has a large CS₉₀/ICT, the set drop strength under the following conditions tends to be large.

Conditions: an electronic device mounted with the chemically strengthened glass, or an electronic device simulating structure, in which the chemically strengthened glass and a casing for holding the chemically strengthened glass are integrated with each other, is dropped from a height of 30 cm onto #80 sandpaper. When the chemically strengthened glass does not crack, a drop height is increased by 5 cm and dropping is performed again. As long as the chemically strengthened glass does not crack after dropping, a step of dropping from a height increased by 5 cm is repeated. A height at which the chemically strengthened glass first cracks is defined as a crack height. The drop test is performed by using 10 samples, and an average crack height of the 10 samples is set as the set drop strength.

The present chemically strengthened glass has 4-point bending strength of preferably 650 MPa or more, more preferably 675 MPa or more, still more preferably 700 MPa or more, and particularly preferably 750 MPa or more.

The shape of the present chemically strengthened glass is not particularly limited, and is typically a sheet shape, or may be flat or curved shape. The glass may have portions having different thicknesses.

In the case where the chemically strengthened glass has a sheet shape, the thickness (t) thereof is preferably 3.0 mm or less, and more preferably 2.0 mm or less, 1.6 mm or less, 1.5 mm or less, 1.1 mm or less, 0.9 mm or less, 0.80 mm or less, or 0.70 mm or less in a stepwise manner. In addition, the thickness (t) is preferably 0.30 mm or more, more preferably 0.40 mm or more, and still more preferably 0.50 mm or more, in order to obtain sufficient strength by the chemical strengthening treatment.

The present chemically strengthened glass is particularly useful as a cover glass used in an electronic device such as a mobile device such as a mobile phone or a smartphone. Further, the present chemically strengthened glass is also useful for a cover glass of an electronic device such as a television, a personal computer, and a touch panel, an elevator wall surface, or a wall surface (full-screen display) of a construction such as a house and a building, which is not intended to be carried. In addition, the present chemically strengthened glass is also useful as a building material such as a window glass, a table top, an interior of an automobile, an airplane, or the like, and a cover glass thereof, or useful for a casing having a curved surface shape.

### Examples

Hereinafter, the present invention will be described with reference to Examples, but the present invention is not limited thereto.

### <Preparation of Glass for Chemical Strengthening>

Glass raw materials were blended so as to have the following compositions shown in mole percentage in terms of oxide, and weighed to obtain 400 g of glass. Next, the mixed raw materials were charged into a platinum crucible, followed by charging into an electric furnace at 1500° C. to 1700° C., melted for about 3 hours, defoamed, and homogenized.

Glass material A: 68% of SiO₂, 12% of Al₂O₃, 1.4% of Y₂O₃, 10.7% of Li₂O, 1.6% of Na₂O, 1.8% of K₂O, 3.5% of MgO, and 1% of other components.

Glass material B: 66.2% of SiO₂, 11.2% of Al₂O₃, 0.5% of Y₂O₃, 10.4% of Li₂O, 5.6% of Na₂O, 1.5% of K₂O, 3.1% of MgO, and 1.5% of other components.

The obtained molten glass was poured into a metal mold, maintained at a temperature about 50° C. higher than the glass transition point for 1 hour, and then cooled to room temperature at a rate of 0.5° C./min, to obtain a glass block. The obtained molten glass was poured into a mold, held at a temperature around the glass transition point (714° C.) for about 1 hour, and then cooled to room temperature at a rate of 0.5° C./min, to obtain a glass block.

The obtained glass block was cut, ground, and finally mirror-polished on both surfaces to obtain glass sheets (glass for chemical strengthening) of 120 mm×60 mm each having a thickness of 0.70 mm or 0.50 mm.

### <Chemical Strengthening Treatment and Evaluation on Chemically Strengthened Glass>

The glass sheet obtained above was immersed in a molten salt composition under conditions shown in Tables 1 to 3, and subjected to a first ion exchange treatment and a second ion exchange treatment, to obtain chemically strengthened glasses in Examples 1 to 16. In the liquid dropping step (first liquid dropping step) after the strengthening step as the first ion exchange treatment, a heat treatment was performed under the conditions shown in Tables 1 to 3. The “liquid dropping temperature” represents the heat treatment temperature, and the “liquid dropping time” represents the heat treatment time. Examples 3, 4, 7, 9 to 16, 20, 21, and 25 are Inventive Examples, and Examples 1, 2, 5, 6, 8, 17 to 19, and 22 to 24 are Comparative Examples. The obtained chemically strengthened glasses were evaluated by the following methods. The results are shown in Tables 1 to 3.

[Stress Measurement with Scattered Light Photoelastic Stress Meter]

The stress of the chemically strengthened glass was measured by the method described in WO 2018/056121 by using a scattered light photoelastic stress meter (SLP-2000 manufactured by Orihara Industrial Co., Ltd.). A stress profile was calculated by using attached software [SlpV (Ver. 2019.11.07.001)] of the scattered light photoelastic stress meter (SLP-2000 manufactured by Orihara Industrial Co., Ltd.).

A function used for obtaining the stress profile is σ(x)=[a₁×erfc(a₂×x)+a₃×erfc(a₄×x)+a₅]. aᵢ (i=1 to 5) is a fitting parameter, and erfc is a complementary error function. The complementary error function is defined by the following equation.

$$\begin{matrix}erfc ( x ) = 1 - erf ( x ) \\ = \frac{2}{\sqrt{π}} {\int }_{x}^{∞} {e}^{- {t}^{2}} dt = {e}^{- {x}^{2}} erfc x ( x )\end{matrix} \qquad [ Math . 9 ]$$

In the evaluation in the present description, the fitting parameter was optimized by minimizing a residual sum of squares of the obtained raw data and the above-described function. As the measurement treatment conditions, a single shot was performed, and regarding measurement region treatment adjustment items, an edge method was designated and selected for the surface, 6.0 μm was designated and selected for the inner surface edge, automatic was designated and selected for the inner left and right edges, automatic was designated and selected for the inner deep edge (center of the film thickness of the sample), and a fitting curve was designated and selected to extend the phase curve to the center of the thickness of the sample.

The stress in the surface layer portion of the glass, which was several tens of μm or less from the glass surface, was measured by using a film stress measurement (FSM 6000-UV manufactured by Orihara Industrial Co., Ltd.) according to the methods described in WO 2018/056121 and WO 2017/115811.

At the same time, the concentration distribution of alkali metal ions (sodium ion and potassium ion) in a cross-sectional direction was measured by using an electron probe micro analyzer (EPMA), and it was confirmed that there was no contradiction with the obtained stress profile.

Based on the above-described measurement results and the obtained stress profile, values of CS₀, CS₁, CS₃, DOL-tail, CSₓ′, CSₓ″, CS₅₀, CS₉₀, DOC, ICT, CT-Max, CTave were obtained. The maximum values and the minimum values of CSₓ′ and CSₓ″ are shown in Tables 1 to 3.

### [Na Ion Concentration Profile]

The Na ion concentration at a depth x (μm) was obtained by measuring a concentration in a cross section in the sheet thickness direction by using an electron probe micro analyzer (EPMA). Specifically, the measurement by using an EPMA was performed as follows. First, a glass sample was embedded with an epoxy resin and mechanically polished in a direction perpendicular to a first main surface and a second main surface opposite to the first main surface to prepare a cross section sample. A C coat was applied to the polished cross section, and measurement was performed by using an EPMA (JXA-8500F manufactured by JEOL Ltd.). A line profile of an X-ray intensity of each of the Na ion concentration and a Si ion concentration was acquired at an interval of 1 μm at an acceleration voltage of 15 kV, a probe current of 30 nA, and an integration time of 1000 msec./point. The obtained Na ion concentration profile was normalized by being divided by an average count of the Si ion concentration at a thickness center portion (500×t)±25 μm (sheet thickness t [mm]). An Na₂O concentration at a specific depth was calculated by proportionally converting counts of the entire sheet thickness into the Na₂O concentration in mol %, assuming that the average count at the thickness center portion (500×t)±25 μm (sheet thickness t [mm]) corresponded to a Na₂O concentration in a base composition of a chemically strengthened glass.

### [Set Drop Strength Test]

In a drop strength test, glass samples of 120 mm×60 mm×0.7 mm, 0.6 mm, and 0.5 mm were each fitted into a structure, whose mass and rigidity were adjusted to the size of a smartphone commonly used at the time of filing, to prepare a pseudo-smartphone casing, #180 SiC sandpaper or #80 SiC sandpaper was provided on a marble placed horizontally on the floor in a manner of being parallel to the marble, and the pseudo-smartphone casing was allowed to freely drop onto the #180 SiC sandpaper or the #80 SiC sandpaper in a state of being horizontal to the sandpaper.

For the drop height, the pseudo-smartphone casing was dropped starting from a height of 30 cm, and in the case where it did not crack, the step was repeated by increasing the height by 5 cm and performing dropping again until it cracked. The height at which the pseudo-smartphone casing first cracked was defined as the drop height. The results of the average crack height when the drop test was performed on 10 sheets in each example are shown in Tables 1 to 3 as “SP #180 drop strength” or “SP #80 drop strength”.

### [4PB Strength (4-Point Bending Strength)]

The chemically strengthened glass was processed into a strip shape of 120 mm×60 mm, and a 4-point bending test was performed under the conditions including a distance between external fulcrums of a support of 30 mm, a distance between internal fulcrums of the support of 10 mm, and a crosshead soeed of 5.0 mm/min to measure the 4-point bending strength. The number of the test pieces was 10. The chemically strengthened glass was processed into a strip shape, and then subjected to automatic chamfering (C-chamfering) by using a grindstone having a grit count of 1000 (manufactured by Tokyo Diamond Tools MFG. Co., Ltd.), and an end surface thereof was mirror-finished by using a nylon brush having a diameter of 0.1 mm and SHOROX NZ abrasive grains (manufactured by Showa Denko Co., Ltd.) to obtain a glass of 120 mm×60 mm×0.7 mm in thickness to be measured.

TABLE 1

| | | Ex. 1 | Ex. 2 | Ex. 3 | Ex. 4 | Ex. 5 | Ex. 6 | Ex. 7 | Ex. 8 |
|---|---|---|---|---|---|---|---|---|---|
| Glass | Glass material | A | A | A | A | A | B | B | B |
| material | name | | | | | | | | |
| | K1c (MPa · m^{1/2}) | 0.82 | 0.82 | 0.82 | 0.82 | 0.82 | 0.8 | 0.8 | 0.8 |
| | Li₂O (mol %) | 10.7 | 10.7 | 10.7 | 10.7 | 10.7 | 10.4 | 10.4 | 10.4 |
| | Na₂O (mol %) | 1.6 | 1.6 | 1.6 | 1.6 | 1.6 | 5.6 | 5.6 | 5.6 |
| | K₂O (mol %) | 1.8 | 1.8 | 1.8 | 1.8 | 1.8 | 1.5 | 1.5 | 1.5 |
| Thickness t (mm) | | 0.7 | 0.7 | 0.7 | 0.7 | 0.7 | 0.7 | 0.7 | 0.7 |
| First ion | First molten salt | KNO₃ 60 | KNO₃ 60 | KNO₃ 60 | KNO₃ 60 | KNO₃ 60 | KNO₃ 60 | KNO₃ 60 | KNO₃ 60 |
| exchange | composition | NaNO₃ 40 | NaNO₃ 40 | NaNO₃ 40 | NaNO₃ 40 | NaNO₃ 40 | NaNO₃ 40 | NaNO₃ 40 | NaNO₃ 40 |
| treatment | (mass %) | | | | | | | | |
| | Strengthening | 420 | 420 | 420 | 420 | 420 | 410 | 410 | 410 |
| | temperature | | | | | | | | |
| | (° C.) | | | | | | | | |
| | Strengthening | 150 | 150 | 150 | 150 | 150 | 180 | 180 | 180 |
| | time (min) | | | | | | | | |
| | Liquid dropping | 380 | 420 | 420 | 420 | 340 | 340 | 340 | 360 |
| | temperature (° C.) | | | | | | | | |
| | Liquid dropping | 3 | 3 | 15 | 45 | 3 | 3 | 20 | 3 |
| | time (min) | | | | | | | | |
| | Strengthening | 8487 | 8487 | 8487 | 8487 | 8487 | 9163 | 9163 | 9163 |
| | index H | | | | | | | | |
| | Heat treatment | 185 | 188 | 234 | 296 | 183 | 214 | 269 | 216 |
| | effect index I | | | | | | | | |
| | CTave (MPa) | 74 | 74 | 74 | 74 | 74 | 68 | 68 | 68 |
| | CTA (MPa) | 75 | 73 | 72 | 68 | 75 | 72 | 73 | 73 |
| Second ion | Second molten salt | KNO₃ 99.7 | KNO₃ 99.7 | KNO₃ 99.7 | KNO₃ 99.7 | KNO₃ 99.7 | KNO₃ 99.3 | KNO₃ 99.3 | KNO₃ 99.3 |
| exchange | composition | LiNO₃ 0.3 | LiNO₃ 0.3 | LiNO₃ 0.3 | LiNO₃ 0.3 | LiNO₃ 0.3 | NaNO₃ 0.6 | NaNO₃ 0.6 | NaNO₃ 0.6 |
| treatment | (mass %) | | | | | | LiNO₃ 0.1 | LiNO₃ 0.1 | LiNO₃ 0.1 |
| | Temperature (° C.) | 420 | 420 | 420 | 420 | 420 | 390 | 390 | 390 |
| | Time (min) | 20 | 20 | 20 | 20 | 20 | 60 | 60 | 60 |
| FSM | CS₀ (MPa) | 809 | 810 | 808 | 809 | 808 | 921 | 928 | 941 |
| profile | CS₁ (MPa) | 590 | 590 | 585 | 560 | 595 | 678 | 684 | 681 |
| | CS₃ (MPa) | 151 | 151 | 138 | 62 | 170 | 192 | 196 | 160 |
| | DOL-tail (μm) | 3.3 | 3.3 | 3.3 | 3.3 | 3.4 | 3.4 | 3.4 | 3.4 |
| SLP | CSₓ″ maximum | 0.0272 | 0.0243 | 0.0187 | 0.0117 | 0.0242 | 0.0448 | 0.0286 | 0.0420 |
| profile | value | | | | | | | | |
| | CSₓ″ minimum | 0.0004 | 0.0004 | 0.0003 | 0.0001 | 0.0004 | 0.0011 | 0.0007 | 0.0010 |
| | value | | | | | | | | |
| | CSₓ′ maximum | −1.8054 | −1.7214 | −1.6000 | −1.3572 | −1.7332 | −1.2306 | −1.2507 | −1.1733 |
| | value | | | | | | | | |
| | CSₓ′ minimum | −3.7671 | −3.5737 | −3.0357 | −2.2280 | −3.5205 | −4.3857 | −3.6369 | −4.2646 |
| | value | | | | | | | | |
| | CS₅₀ (MPa) | 134.7 | 144.4 | 141.6 | 127.2 | 137.2 | 113.1 | 121.5 | 117.4 |
| | CS₉₀ (MPa) | 26.7 | 38.0 | 45.5 | 51.0 | 32.9 | 29.6 | 36.2 | 33.8 |
| | DOC (μm) | 103.0 | 109.0 | 114.5 | 122.5 | 106.5 | 111.0 | 114.5 | 114.5 |
| | ICT (MPa · μm) | 34160.2 | 33531.8 | 32489.0 | 30025.6 | 33714.8 | 30009.0 | 29312.7 | 29461.6 |
| | CT-Max (MPa) | 81.0 | 82.5 | 83.8 | 83.9 | 82.0 | 80.5 | 80.0 | 82.4 |
| | CTave (MPa) | 68.8 | 69.2 | 68.7 | 65.7 | 68.9 | 62.4 | 61.9 | 62.2 |
| | CS₅₀/ICT (μm⁻¹) | 0.0039 | 0.0043 | 0.0044 | 0.0042 | 0.0041 | 0.0038 | 0.0041 | 0.0040 |
| | CS₉₀/ICT (μm⁻¹) | 0.0008 | 0.0011 | 0.0014 | 0.0017 | 0.0010 | 0.0010 | 0.0012 | 0.0011 |
| | DOC/CS₅₀ | 0.76 | 0.75 | 0.81 | 0.96 | 0.78 | 0.98 | 0.94 | 0.98 |
| | (μm/MPa) | | | | | | | | |
| | CS₉₀/CS₅₀ | 0.20 | 0.26 | 0.32 | 0.40 | 0.24 | 0.26 | 0.30 | 0.29 |
| Na ion | Na ion diffusion | 195 | 208 | 220 | 237 | 202 | — | — | — |
| distribution | depth (μm) | | | | | | | | |
| | ΔNa50 (mol %) | 3.48 | 3.71 | 3.64 | 3.31 | 3.54 | — | — | — |
| | ΔNa90 (mol %) | 1.90 | 1.98 | 2.09 | 2.15 | 1.96 | — | — | — |
| | ΔNa90/ΔNa50 | 0.55 | 0.53 | 0.57 | 0.65 | 0.55 | — | — | — |
| | ΔNa90/Na in base | 1.19 | 1.24 | 1.31 | 1.34 | 1.23 | — | — | — |
| | composition | | | | | | | | |
| Strength | SP#180 drop | 83 | 88 | 87 | 79 | 84 | 72 | 76 | 74 |
| | strength (cm) | | | | | | | | |
| | SP#80 drop | 38.0 | 41.0 | 43.0 | 44.0 | 39.5 | 39.0 | 40.5 | 40.0 |
| | strength (cm) | | | | | | | | |
| | 4PB strength (MPa) | 690 | 690 | 686 | 668 | 694 | 754 | 758 | 756 |

TABLE 2

| | | Ex. 9 | Ex. 10 | Ex. 11 | Ex. 12 | Ex. 13 | Ex. 14 | Ex. 15 | Ex. 16 |
|---|---|---|---|---|---|---|---|---|---|
| Glass | Glass material | B | B | B | B | B | B | B | B |
| material | name | | | | | | | | |
| | K1c (MPa · m^{1/2}) | 0.8 | 0.8 | 0.8 | 0.8 | 0.8 | 0.8 | 0.8 | 0.8 |
| | Li₂O (mol %) | 10.4 | 10.4 | 10.4 | 10.4 | 10.4 | 10.4 | 10.4 | 10.4 |
| | Na₂O (mol %) | 5.6 | 5.6 | 5.6 | 5.6 | 5.6 | 5.6 | 5.6 | 5.6 |
| | K₂O (mol %) | 1.5 | 1.5 | 1.5 | 1.5 | 1.5 | 1.5 | 1.5 | 1.5 |
| Thickness t (mm) | | 0.7 | 0.7 | 0.7 | 0.7 | 0.7 | 0.7 | 0.7 | 0.7 |
| First ion | First molten salt | KNO₃ 60 | KNO₃ 60 | KNO₃ 60 | KNO₃ 60 | KNO₃ 60 | KNO₃ 60 | KNO₃ 60 | KNO₃ 60 |
| exchange | composition | NaNO₃ 40 | NaNO₃ 40 | NaNO₃ 40 | NaNO₃ 40 | NaNO₃ 40 | NaNO₃ 40 | NaNO₃ 40 | NaNO₃ 40 |
| treatment | (mass %) | | | | | | | | |
| | Strengthening | 410 | 410 | 410 | 410 | 410 | 410 | 410 | 410 |
| | temperature | | | | | | | | |
| | (° C.) | | | | | | | | |
| | Strengthening | 180 | 180 | 180 | 240 | 240 | 240 | 240 | 240 |
| | time (min) | | | | | | | | |
| | Liquid dropping | 360 | 375 | 375 | 340 | 380 | 420 | 420 | 420 |
| | temperature (° C.) | | | | | | | | |
| | Liquid dropping | 20 | 10 | 20 | 3 | 3 | 3 | 15 | 45 |
| | time (min) | | | | | | | | |
| | Strengthening | 9163 | 9163 | 9163 | 10581 | 10581 | 10581 | 10581 | 10581 |
| | index H | | | | | | | | |
| | Heat treatment | 272 | 246 | 274 | 266 | 267 | 269 | 305 | 353 |
| | effect index I | | | | | | | | |
| | CTave (MPa) | 68 | 68 | 68 | 68 | 68 | 68 | 68 | 68 |
| | CTA (MPa) | 71 | 66 | 73 | 74 | 74 | 74 | 69 | 60 |
| Second ion | Second molten | KNO₃ 99.3 | KNO₃ 99.3 | KNO₃ 99.3 | KNO₃ 99.3 | KNO₃ 99.3 | KNO₃ 99.3 | KNO₃ 99.3 | KNO₃ 99.3 |
| exchange | salt composition | NaNO₃ 0.6 | NaNO₃ 0.6 | NaNO₃ 0.6 | NaNO₃ 0.6 | NaNO₃ 0.6 | NaNO₃ 0.6 | NaNO₃ 0.6 | NaNO₃ 0.6 |
| treatment | (mass %) | LiNO₃ 0.1 | LiNO₃ 0.1 | LiNO₃ 0.1 | LiNO₃ 0.1 | LiNO₃ 0.1 | LiNO₃ 0.1 | LiNO₃ 0.1 | LiNO₃ 0.1 |
| | Temperature (° C.) | 390 | 390 | 390 | 390 | 390 | 390 | 390 | 390 |
| | Time (min) | 60 | 60 | 60 | 60 | 60 | 60 | 60 | 60 |
| FSM | CS₀ (MPa) | 921 | 908 | 912 | 939 | 937 | 935 | 931 | 926 |
| profile | CS₁ (MPa) | 680 | 677 | 666 | 684 | 689 | 679 | 678 | 585 |
| | CS₃ (MPa) | 198 | 215 | 174 | 176 | 193 | 165 | 173 | 231 |
| | DOL-tail (μm) | 3.6 | 3.8 | 3.5 | 3.9 | 3.9 | 3.8 | 3.9 | 6.3 |
| SLP | CSₓ″ maximum | 0.0301 | 0.0370 | 0.0293 | 0.0174 | 0.0161 | 0.0190 | 0.0103 | 0.0052 |
| profile | value | | | | | | | | |
| | CSₓ″ minimum | 0.0007 | 0.0009 | 0.0008 | 0.0003 | 0.0003 | 0.0005 | 0.0001 | 0.0000 |
| | value | | | | | | | | |
| | CSₓ′ maximum | −1.1467 | −1.1647 | −1.1713 | −1.2923 | −1.2868 | −1.2841 | −1.1782 | −0.8947 |
| | value | | | | | | | | |
| | CSₓ′ minimum | −3.5842 | −3.9661 | −3.4929 | −2.8648 | −2.8041 | −3.0690 | −2.0764 | −1.2966 |
| | value | | | | | | | | |
| | CS₅₀ (MPa) | 117.2 | 117.7 | 114.0 | 133.2 | 131.6 | 126.9 | 122.5 | 95.7 |
| | CS₉₀ (MPa) | 36.7 | 35.8 | 36.1 | 47.7 | 48.8 | 44.5 | 52.6 | 48.4 |
| | DOC (μm) | 117.0 | 116.0 | 116.5 | 120.5 | 122.0 | 119.5 | 128.0 | 137.5 |
| | ICT (MPa · μm) | 27522.8 | 28301.4 | 28723.4 | 32072.1 | 32651.5 | 32391.5 | 29678.5 | 24588.3 |
| | CT-Max (MPa) | 76.9 | 78.9 | 80.4 | 96.4 | 97.5 | 94.3 | 92.1 | 85.6 |
| | CTave (MPa) | 58.7 | 60.1 | 61.2 | 69.5 | 71.2 | 69.9 | 66.4 | 57.5 |
| | CS₅₀/ICT (μm⁻¹) | 0.0043 | 0.0042 | 0.0040 | 0.0042 | 0.0040 | 0.0039 | 0.0041 | 0.0039 |
| | CS₉₀/ICT (μm⁻¹) | 0.0013 | 0.0013 | 0.0013 | 0.0015 | 0.0015 | 0.0014 | 0.0018 | 0.0020 |
| | DOC/CS₅₀ | 1.00 | 0.99 | 1.02 | 0.90 | 0.93 | 0.94 | 1.04 | 1.44 |
| | (μm/MPa) | | | | | | | | |
| | CS₉₀/CS₅₀ | 0.31 | 0.30 | 0.32 | 0.36 | 0.37 | 0.35 | 0.43 | 0.51 |
| Na ion | Na ion diffusion | — | — | — | — | — | — | — | — |
| distribution | depth (μm) | | | | | | | | |
| | ΔNa50 (mol %) | — | — | — | — | — | — | — | — |
| | ΔNa90 (mol %) | — | — | — | — | — | — | — | — |
| | ΔNa90/ΔNa50 | — | — | — | — | — | — | — | — |
| | ΔNa90/Na in base | — | — | — | — | — | — | — | — |
| | composition | | | | | | | | |
| Strength | SP#180 drop | 74 | 74 | 72 | 82 | 81 | 79 | 77 | 62 |
| | strength (cm) | | | | | | | | |
| | SP#80 drop | 41.0 | 40.5 | 40.5 | 43.5 | 43.5 | 42.5 | 44.5 | 43.5 |
| | strength (cm) | | | | | | | | |
| | 4PB strength (MPa) | 756 | 753 | 745 | 759 | 762 | 755 | 754 | 686 |

TABLE 3

| | | Ex. 17 | Ex. 18 | Ex. 19 | Ex. 20 | Ex. 21 |
|---|---|---|---|---|---|---|
| Glass | Glass material | A | A | A | A | A |
| material | name | | | | | |
| | K1c (MPa · m^{1/2}) | 0.82 | 0.82 | 0.82 | 0.82 | 0.82 |
| | Li₂O (mol %) | 10.7 | 10.7 | 10.7 | 10.7 | 10.7 |
| | Na₂O (mol %) | 1.6 | 1.6 | 1.6 | 1.6 | 1.6 |
| | K₂O (mol %) | 1.8 | 1.8 | 1.8 | 1.8 | 1.8 |
| Thickness t (mm) | | 0.6 | 0.6 | 0.6 | 0.6 | 0.6 |
| First ion | First molten salt | KNO₃ 60 | KNO₃ 60 | KNO₃ 60 | KNO₃ 60 | KNO₃ 60 |
| exchange | composition | NaNO₃ 40 | NaNO₃ 40 | NaNO₃ 40 | NaNO₃ 40 | NaNO₃ 40 |
| treatment | (mass %) | | | | | |
| | Strengthening | 420 | 420 | 420 | 420 | 420 |
| | temperature | | | | | |
| | (° C.) | | | | | |
| | Strengthening | 150 | 150 | 150 | 150 | 150 |
| | time (min) | | | | | |
| | Liquid dropping | 340 | 380 | 420 | 420 | 420 |
| | temperature (° C.) | | | | | |
| | Liquid dropping | 3 | 3 | 3 | 15 | 45 |
| | time (min) | | | | | |
| | Strengthening | 8487 | 8487 | 8487 | 8487 | 8487 |
| | index H | | | | | |
| | Heat treatment | 183 | 185 | 188 | 234 | 296 |
| | effect index I | | | | | |
| | CTave (MPa) | 76 | 76 | 76 | 76 | 76 |
| | CTA (MPa) | 85 | 86 | 83 | 78 | 74 |
| Second ion | Second molten salt | KNO₃ 99.7 | KNO₃ 99.7 | KNO₃ 99.7 | KNO₃ 99.7 | KNO₃ 99.7 |
| exchange | composition | LiNO₃ 0.3 | LiNO₃ 0.3 | LiNO₃ 0.3 | LiNO₃ 0.3 | LiNO₃ 0.3 |
| treatment | (mass %) | | | | | |
| | Temperature (° C.) | 420 | 420 | 420 | 420 | 420 |
| | Time (min) | 20 | 20 | 20 | 20 | 20 |
| FSM | CS₀ (MPa) | 794 | 766 | 749 | 780 | 794 |
| profile | CS₁ (MPa) | 591 | 578 | 563 | 552 | 554 |
| | CS₃ (MPa) | 186 | 202 | 191 | 95 | 75 |
| | DOL-tail (μm) | 3.5 | 3.4 | 3.6 | 3.4 | 3.4 |
| SLP | CSₓ″ maximum | 0.0335 | 0.0302 | 0.0298 | 0.0240 | 0.0088 |
| profile | value | | | | | |
| | CSₓ″ minimum | −0.0860 | −0.1407 | −0.0814 | −0.0577 | −0.0187 |
| | value | | | | | |
| | CSₓ′ maximum | 0.2933 | 1.6480 | 0.2388 | 0.1183 | 0.0000 |
| | value | | | | | |
| | CSₓ′ minimum | −3.0761 | −3.1446 | −2.9247 | −2.4485 | −1.5616 |
| | value | | | | | |
| | CS₅₀ (MPa) | 147.8 | 150.7 | 145.6 | 134.7 | 104.7 |
| | CS₉₀ (MPa) | 30.7 | 33.3 | 33.9 | 41.0 | 51.9 |
| | DOC (μm) | 102.5 | 104.5 | 104.5 | 109.5 | 123.5 |
| | ICT (MPa · μm) | 31417.6 | 31324.2 | 30847.5 | 28830.7 | 24907.6 |
| | CT-Max (MPa) | 98.3 | 101.1 | 99.1 | 96.7 | 97.8 |
| | CTave (MPa) | 79.5 | 80.1 | 78.9 | 75.7 | 70.6 |
| | CS₅₀/ICT (μm⁻¹) | 0.0047 | 0.0048 | 0.0047 | 0.0047 | 0.0042 |
| | CS₉₀/ICT (μm⁻¹) | 0.0010 | 0.0011 | 0.0011 | 0.0014 | 0.0021 |
| | DOC/CS₅₀ | 0.69 | 0.69 | 0.72 | 0.81 | 1.18 |
| | (μm/MPa) | | | | | |
| | CS₉₀/CS₅₀ | 0.21 | 0.22 | 0.23 | 0.30 | 0.50 |
| Na ion | Na ion diffusion | 194 | 198 | 198 | 209 | 240 |
| distribution | depth (μm) | | | | | |
| | ΔNa50 (mol %) | 3.78 | 3.85 | 3.73 | — | 2.79 |
| | ΔNa90 (mol %) | 1.94 | 1.97 | 1.97 | — | 2.15 |
| | ΔNa90/ΔNa50 | 0.51 | 0.51 | 0.53 | — | 0.77 |
| | ΔNa90/Na in base | 1.21 | 1.23 | 1.23 | — | 1.35 |
| | composition | | | | | |
| Strength | SP#180 drop | 90 | 92 | 89 | 83 | 67 |
| | strength (cm) | | | | | |
| | SP#80 drop | 39.0 | 40.0 | 40.0 | 42.0 | 44.5 |
| | strength (cm) | | | | | |
| | 4PB strength (MPa) | 691 | 681 | 670 | 662 | 664 |

| | | Ex. 22 | Ex. 23 | Ex. 24 | Ex. 25 |
|---|---|---|---|---|---|
| Glass | Glass material | A | A | A | A |
| material | name | | | | |
| | K1c (MPa · m^{1/2}) | 0.82 | 0.82 | 0.82 | 0.82 |
| | Li₂O (mol %) | 10.7 | 10.7 | 10.7 | 10.7 |
| | Na₂O (mol %) | 1.6 | 1.6 | 1.6 | 1.6 |
| | K₂O (mol %) | 1.8 | 1.8 | 1.8 | 1.8 |
| Thickness t (mm) | | 0.5 | 0.5 | 0.5 | 0.5 |
| First ion | First molten salt | KNO₃ 60 | KNO₃ 60 | KNO₃ 60 | KNO₃ 60 |
| exchange | composition | NaNO₃ 40 | NaNO₃ 40 | NaNO₃ 40 | NaNO₃ 40 |
| treatment | (mass %) | | | | |
| | Strengthening | 420 | 420 | 420 | 420 |
| | temperature | | | | |
| | (° C.) | | | | |
| | Strengthening | 150 | 150 | 150 | 150 |
| | time (min) | | | | |
| | Liquid dropping | 340 | 380 | 420 | 420 |
| | temperature (° C.) | | | | |
| | Liquid dropping | 3 | 3 | 3 | 45 |
| | time (min) | | | | |
| | Strengthening | 8487 | 8487 | 8487 | 8487 |
| | index H | | | | |
| | Heat treatment | 183 | 185 | 188 | 296 |
| | effect index I | | | | |
| | CTave (MPa) | 85 | 85 | 85 | 85 |
| | CTA (MPa) | 93 | 93 | 91 | 75 |
| Second ion | Second molten salt | KNO₃ 99.7 | KNO₃ 99.7 | KNO₃ 99.7 | KNO₃ 99.7 |
| exchange | composition | LiNO₃ 0.3 | LiNO₃ 0.3 | LiNO₃ 0.3 | LiNO₃ 0.3 |
| treatment | (mass %) | | | | |
| | Temperature (° C.) | 420 | 420 | 420 | 420 |
| | Time (min) | 20 | 20 | 20 | 20 |
| FSM | CS₀ (MPa) | 749 | 738 | 730 | 796 |
| profile | CS₁ (MPa) | 566 | 554 | 547 | 546 |
| | CS₃ (MPa) | 199 | 187 | 181 | 47 |
| | DOL-tail (μm) | 3.6 | 3.6 | 3.5 | 3.4 |
| SLP | CSₓ″ maximum | 0.0312 | 0.0313 | 0.0294 | 0.0049 |
| profile | value | | | | |
| | CSₓ″ minimum | −0.0704 | −0.1108 | −0.0775 | −0.0170 |
| | value | | | | |
| | CSₓ′ maximum | 0.0000 | 0.9129 | 0.0909 | 0.0000 |
| | value | | | | |
| | CSₓ′ minimum | −3.0350 | −3.1019 | −2.9193 | −1.6058 |
| | value | | | | |
| | CS₅₀ (MPa) | 128.5 | 136.7 | 130.3 | 91.6 |
| | CS₉₀ (MPa) | 13.7 | 19.4 | 18.6 | 37.3 |
| | DOC (μm) | 95.5 | 98.0 | 97.5 | 113.0 |
| | ICT (MPa · μm) | 25950.2 | 25578.0 | 25497.4 | 19843.6 |
| | CT-Max (MPa) | 112.4 | 113.4 | 112.9 | 108.2 |
| | CTave (MPa) | 84.0 | 84.1 | 83.6 | 72.4 |
| | CS₅₀/ICT (μm⁻¹) | 0.0050 | 0.0053 | 0.0051 | 0.0046 |
| | CS₉₀/ICT (μm⁻¹) | 0.0005 | 0.0008 | 0.0007 | 0.0019 |
| | DOC/CS₅₀ | 0.74 | 0.72 | 0.75 | 1.23 |
| | (μm/MPa) | | | | |
| | CS₉₀/CS₅₀ | 0.11 | 0.14 | 0.14 | 0.41 |
| Na ion | Na ion diffusion | 179 | 184 | 183 | 217 |
| distribution | depth (μm) | | | | |
| | ΔNa50 (mol %) | 3.34 | 3.53 | 3.38 | 2.48 |
| | ΔNa90 (mol %) | 1.77 | 1.83 | 1.82 | 2.01 |
| | ΔNa90/ΔNa50 | 0.53 | 0.52 | 0.54 | 0.81 |
| | ΔNa90/Na in base | 1.11 | 1.14 | 1.14 | 1.26 |
| | composition | | | | |
| Strength | SP#180 drop | 80 | 84 | 81 | 60 |
| | strength (cm) | | | | |
| | SP#80 drop | 35.0 | 36.5 | 36.0 | 41.0 |
| | strength (cm) | | | | |
| | 4PB strength (MPa) | 672 | 664 | 658 | 658 |

FIG. 1 shows stress profiles of the chemically strengthened glasses in Example 5 and Example 3, as measured with an SLP. FIG. 2 shows Na ion concentration profiles of the chemically strengthened glasses in Example 5 and Example 3.

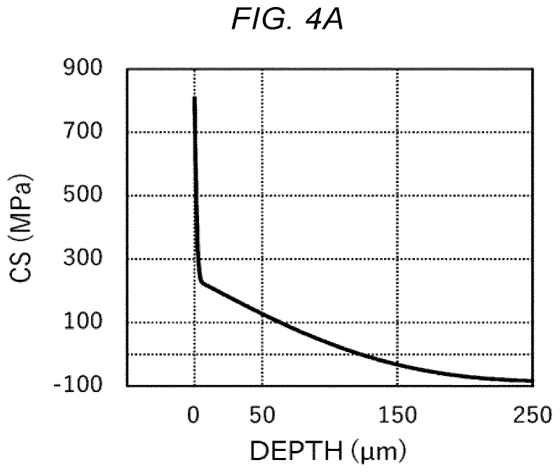

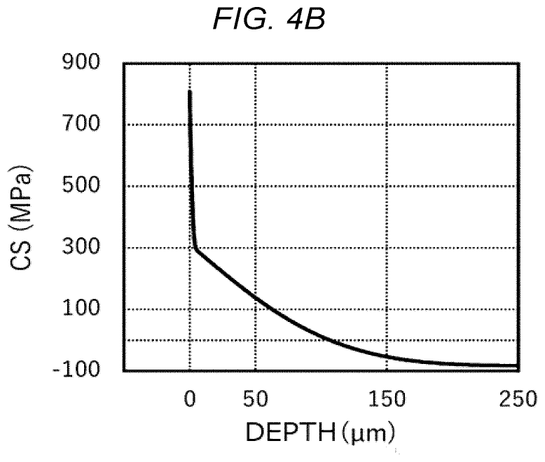

FIG. 4A shows a stress profile of the chemically strengthened glass in Example 4, and FIG. 4B shows a stress profile of the chemically strengthened glass in Example 5. The stress profile shown in each of FIGS. 4A and 4B is prepared by combining stress profile information of a glass surface layer measured by using an SLP and stress profile information inside the glass measured by using an FSM. The software “PMC” manufactured by Orihara Industrial Co., Ltd. was used to synthesize the stress profile.

As can be seen from the results shown in Table 1 and FIGS. 1, 2 and 4A and 41B, the chemically strengthened glass in Inventive Examples in which a heat treatment is performed under a condition where the heat treatment effect index value is 220 or more after the first ion exchange treatment and before the second ion exchange treatment has a relatively large CS₉₀/ICT and DOC and a relatively large CS₉₀ value with respect to a total compressive stress. In addition, the chemically strengthened glass in Inventive Examples tends to have a relatively large ΔNa90/ΔNa50 and Na ion diffusion depth. Then, the chemically strengthened glass in Inventive Examples has excellent strength, particularly SP #80 drop strength. For example, as a result of comparing Examples 1 to 5, Examples 6 to 16, Examples 17 to 21, and Examples 22 to 25 with the same thickness and composition of the glass for chemical strengthening, all of the chemically strengthened glasses in Inventive Examples have SP #80 drop strength more excellent than that of the chemically strengthened glasses in Comparative Examples.

As described above, the following matters are disclosed in the present description.

1. A chemically strengthened glass having a thickness t [mm], in which
a compressive stress layer depth DOC [μm] is 160t [μm] or more, and a value CS₉₀/ICT [μm⁻¹] obtained by dividing CS₉₀ [MPa] which is a compressive stress value at a depth of 90 μm from a surface of the chemically strengthened glass by a tensile stress integrated value ICT [MPa·μm] is 0.0012 μm⁻¹ or more.

2. The chemically strengthened glass according to the above 1, in which the CS₉₀ is 5+50t [MPa] or more.

3. The chemically strengthened glass according to the above 1 or 2, in which a value DOC/CS₅₀ obtained by dividing the DOC by CS₅₀ [MPa] which is a compressive stress value at a depth of 50 μm from the surface of the chemically strengthened glass is 0.8 μm/MPa or more.

4. The chemically strengthened glass according to any one of the above 1 to 3, in which a value CS₉₀/CS₅₀ obtained by dividing the CS₉₀ by the CS₅₀ [MPa] which is the compressive stress value at the depth of 50 μm from the surface of the chemically strengthened glass is 0.30 or more.

5. The chemically strengthened glass according to any one of the above 1 to 4, in which in a profile of a stress value CSₓ [MPa] at a depth x [μm] from the surface of the chemically strengthened glass as measured with a scattered light photoelastic stress meter, a first-order differential value CSₓ′ of the stress value CSₓ in a range of CSₓ≥0 is less than 2.

6. The chemically strengthened glass according to any one of the above 1 to 5, in which in the profile of the stress value CSₓ [MPa] at the depth x [μm] from the surface of the chemically strengthened glass as measured with the scattered light photoelastic stress meter, a second-order differential value CSₓ″ of the stress value CSₓ in the range of CSₓ≥0 is −0.02 to 0.06.

7. The chemically strengthened glass according to any one of the above 1 to 6, in which a surface compressive stress value CS₀ is 750 MPa or more as measured with a film stress measurement.

8. The chemically strengthened glass according to any one of the above 1 to 7, in which a set drop strength is 40.5 cm or more as measured by a sandpaper set drop strength test under the following conditions,
conditions: an electronic device mounted with the chemically strengthened glass, or an electronic device simulating structure in which the chemically strengthened glass and a casing for holding the chemically strengthened glass are integrated with each other, is dropped from a height of 30 cm onto #80 sandpaper; when the chemically strengthened glass does not crack, a drop height is increased by 5 cm and dropping is performed again; as long as the chemically strengthened glass does not crack after dropping, a step of dropping from a drop height increased by 5 cm is repeated; a height at which the chemically strengthened glass first cracks is defined as a crack height; and the drop test is performed for 10 samples, and an average crack height of the 10 samples is defined as the set drop strength.

9. A chemically strengthened glass having a thickness t [mm], in which
an Na ion diffusion depth determined based on an Na ion concentration profile in a sheet thickness direction of the chemically strengthened glass as measured by using an electron probe micro analyzer is 290t [μm] or more, and
a ratio ΔNa90/ΔNa50 is 0.55 or more, where the ΔNa50 [mol %] is a difference between an Na₂O concentration in a base composition of the chemically strengthened glass and an Na₂O concentration at a depth of 50 μm from a surface of the chemically strengthened glass, and the ΔNa90 [mol %] is a difference between the Na₂O concentration in the base composition of the chemically strengthened glass and an Na₂O concentration at a depth of 90 μm from the surface of the chemically strengthened glass.

10. The chemically strengthened glass according to the above 9, in which a ratio of the ΔNa90 [mol %] to the Na₂O concentration [mol %] in the base composition of the chemically strengthened glass is 1.26 or more.

11. A production method for a chemically strengthened glass, the method including:
a first ion exchange treatment of bringing a glass for chemical strengthening into contact with a first molten salt composition; and
a second ion exchange treatment of bringing the glass for chemical strengthening into contact with a second molten salt composition after the first ion exchange treatment, in which
the method further includes a heat treatment after the first ion exchange treatment and before the second ion exchange treatment,
a first ion exchange treatment temperature T_{CT} [° C.] and a first ion exchange time t_{CT} [minutes] are in a range where a strengthening index (H value) defined by the following equation is 10600 or less, and
in the heat treatment, a heat treatment effect index value (1 value) defined by the following equation is 220 or more.

$$H = ( {T}_{CT} + 273 ) \times \sqrt{{t}_{CT}} \qquad [ Math . 10 ]$$

$$I = \frac{\sum [ {Me}_{2} O ] \times \sqrt{{t}_{d}} \times ( {T}_{d} + 273 )}{3 {t}_{CT}} + {t}_{CT} \qquad [ Math . 11 ]$$

In the equations,
t_{CT} is a treatment time [minutes] of the first ion exchange treatment,
T_{CT} is a temperature [° C.] of the first ion exchange treatment,
Σ[Me₂O] is a total concentration [mol %] of alkali metal ion oxides in the glass for chemical strengthening,
t_{d} is a time [minutes] during which the glass for chemical strengthening is left at a temperature of 80% or more of the first ion exchange treatment temperature T_{CT} [° C.] as the heat treatment, and
T_{d} is a temperature [° C.] of the heat treatment.

12. The production method for a chemically strengthened glass according to the above 11, in which the heat treatment temperature T_{d} [° C.] is 360° C. or higher, or the heat treatment time t_{d} [minutes] is 10 minutes or longer.

13. The production method for a chemically strengthened glass according to the above 11 or 12, in which
when the glass for chemical strengthening has a CTA value determined according to the following equation (1) of x [MPa], a CTave value of the glass for chemical strengthening, which is determined according to the following equation (2), is made greater than x [MPa] by the first ion exchange treatment, and the CTave value of the glass for chemical strengthening is made less than x [MPa] by the second ion exchange treatment.

$$CTave = ICT / LCT , \qquad Equation ( 2 )$$

t: sheet thickness [mm],
K1c: fracture toughness value [MPa·m^{1/2}],

$$\begin{matrix}[ Math . 12 ] & \\ CTA = 317.93 \times K 1 c / \sqrt{t} + 228.5 \times t - 398 & Equation ( 1 )\end{matrix}$$

ICT: tensile stress integrated value [MPa·μm], and
LCT: sheet thickness direction length [μm] of tensile stress region

### REFERENCE SIGNS LIST

1 Glass for chemical strengthening
25 Atmosphere heater
50 Molten salt bath
55 Molten salt heater
53 Molten salt composition

What is claimed is:

1. A chemically strengthened glass having a thickness t [mm], wherein
a compressive stress layer depth DOC [μm] is 160t [μm] or more, and
a value CS₉₀/ICT [μm⁻¹] obtained by dividing CS₉₀ [MPa] which is a compressive stress value at a depth of 90 μm from a surface of the chemically strengthened glass by a tensile stress integrated value ICT [MPa·μm] is 0.0012 μm⁻¹ or more.

2. The chemically strengthened glass according to claim 1, wherein the CS₉₀ is 5+50t [MPa] or more.

3. The chemically strengthened glass according to claim 1, wherein a value DOC/CS₅₀ obtained by dividing the DOC by CS₅₀ [MPa] which is a compressive stress value at a depth of 50 μm from the surface of the chemically strengthened glass is 0.8 μm/MPa or more.

4. The chemically strengthened glass according to claim 1, wherein a value CS₉₀/CS₅₀ obtained by dividing the CS₉₀ by the CS₅₀ [MPa] which is the compressive stress value at the depth of 50 μm from the surface of the chemically strengthened glass is 0.30 or more.

5. The chemically strengthened glass according to claim 1, wherein in a profile of a stress value CSₓ [MPa] at a depth x [μm] from the surface of the chemically strengthened glass as measured with a scattered light photoelastic stress meter, a first-order differential value CSₓ′ of the stress value CSₓ in a range of CSₓ≥0 is less than 2.

6. The chemically strengthened glass according to claim 1, wherein in the profile of the stress value CSₓ [MPa] at the depth x [μm] from the surface of the chemically strengthened glass as measured with the scattered light photoelastic stress meter, a second-order differential value CSₓ″ of the stress value CSₓ in the range of CSₓ≥0 is −0.02 to 0.06.

7. The chemically strengthened glass according to claim 1, wherein a surface compressive stress value CS₀ is 750 MPa or more as measured with a film stress measurement.

8. The chemically strengthened glass according to claim 1, wherein a set drop strength is 40.5 cm or more as measured by a sandpaper set drop strength test under the following conditions,
conditions: an electronic device mounted with the chemically strengthened glass, or an electronic device simulating structure in which the chemically strengthened glass and a casing for holding the chemically strengthened glass are integrated with each other, is dropped from a height of 30 cm onto #80 sandpaper; when the chemically strengthened glass does not crack, a drop height is increased by 5 cm and dropping is performed again; as long as the chemically strengthened glass does not crack after dropping, a step of dropping from a drop height increased by 5 cm is repeated; a height at which the chemically strengthened glass first cracks is defined as a crack height; and the drop test is performed for 10 samples, and an average crack height of the 10 samples is defined as the set drop strength.

9. A chemically strengthened glass having a thickness t [mm], wherein
an Na ion diffusion depth determined based on an Na ion concentration profile in a sheet thickness direction of the chemically strengthened glass as measured by using an electron probe micro analyzer is 290t [m] or more, and
a ratio ΔNa90/ΔNa50 is 0.55 or more, where the ΔNa50 [mol %] is a difference between an Na₂O concentration in a base composition of the chemically strengthened glass and an Na₂O concentration at a depth of 50 μm from a surface of the chemically strengthened glass, and the ΔNa90 [mol %] is a difference between the Na₂O concentration in the base composition of the chemically strengthened glass and an Na₂O concentration at a depth of 90 μm from the surface of the chemically strengthened glass.

10. The chemically strengthened glass according to claim 9, wherein a ratio of the ΔNa90 [mol %] to the Na₂O concentration [mol %] in the base composition of the chemically strengthened glass is 1.26 or more.

11. A production method for a chemically strengthened glass, the method comprising:
a first ion exchange treatment of bringing a glass for chemical strengthening into contact with a first molten salt composition; and
a second ion exchange treatment of bringing the glass for chemical strengthening into contact with a second molten salt composition after the first ion exchange treatment, wherein the method further comprises a heat treatment after the first ion exchange treatment and before the second ion exchange treatment,
a first ion exchange treatment temperature T_{CT} [° C.] and a first ion exchange time t_{CT} [minutes] are in a range where a strengthening index (H value) defined by the following equation is 10600 or less, and
in the heat treatment, a heat treatment effect index value (I value) defined by the following equation is 220 or more,
$$H = ( {T}_{CT} + 273 ) \times \sqrt{{t}_{CT}} \qquad [ Math . 1 ]$$
$$I = \frac{\sum [ {Me}_{2} O ] \times \sqrt{{t}_{d}} \times ( {T}_{d} + 273 )}{3 {t}_{CT}} + {t}_{CT} \qquad [ Math . 2 ]$$
in the equations,
t_{CT} is a treatment time [minutes] of the first ion exchange treatment,
T_{CT} is a temperature [° C.] of the first ion exchange treatment,
Σ[Me₂O] is a total concentration [mol %] of alkali metal ion oxides in the glass for chemical strengthening,
t_{d} is a time [minutes] during which the glass for chemical strengthening is left at a temperature of 80% or more of the first ion exchange treatment temperature T_{CT} [° C.] as the heat treatment, and
T_{d} is a temperature [° C.] of the heat treatment.

12. The production method for a chemically strengthened glass according to claim 11, wherein the heat treatment temperature T_{d} [° C.] is 360° C. or higher, or the heat treatment time t_{d} [minutes] is 10 minutes or longer.

13. The production method for a chemically strengthened glass according to claim 11, wherein
when the glass for chemical strengthening has a CTA value determined according to the following equation (1) of x [MPa], a CTave value of the glass for chemical strengthening, which is determined according to the following equation (2), is made greater than x [MPa] by the first ion exchange treatment, and the CTave value of the glass for chemical strengthening is made less than x [MPa] by the second ion exchange treatment,
$$\begin{matrix}[ Math . 3 ] & \\ CTA = 317.93 \times K 1 c / \sqrt{t} + 228.5 \times t - 398 & Equation ( 1 )\end{matrix}$$
t: sheet thickness [mm],
K1c: fracture toughness value [MPa·m^{1/2}],
CTave=ICT/LCT Equation (2),
ICT: tensile stress integrated value [MPa·μm], and
LCT: sheet thickness direction length [μm] of tensile stress region.
